(19) United States
(12) Patent Application Publication
(10) Pub. No.: US 2026/0125304 A1
(43) Pub. Date: May 7, 2026

(54) APPARATUS AND METHOD FOR THERMALLY TREATING A BODY TO BE THERMALLY TREATED

(71) Applicant: Carl Zeiss SMT GmbH, Oberkochen (DE)

(72) Inventor: Uwe SCHELLHORN, Aalen (DE)

(21) Appl. No.: 19/439,843

(22) Filed: Jan. 5, 2026

Related U.S. Application Data
(63) Continuation of application No. PCT/EP2024/065995, filed on Jun. 10, 2024.

(30) Foreign Application Priority Data
Jul. 6, 2023 (DE) 10 2023 206 431.6

(51) Int. Cl. C03B 23/00; C03B 25/02; C04B 41/00

(52) U.S. Cl. CPC C03B 23/0086; C03B 23/006; C03B 25/02; C04B 41/0072; C03B 2201/42

(57) ABSTRACT

An apparatus (100) for thermally treating a body (101, 102, 103) to be thermally treated, in particular for thermally connecting a first partial body (101) to a second partial body (102) to form a composite body (103) at an interface (104) between the partial bodies. The apparatus also includes a jacket (105), a temperature-controllable space (108) within a temperature-control unit (106) and a heating element (109), with the jacket contactlessly surrounding the body to be thermally treated before, during and after the thermal treatment. Also disclosed are a method for thermally treating a body to be thermally treated, e.g., for high-temperature bonding of a first partial body to a second partial body (102) to form a composite body (103), an optical element (609), e.g., a reflective optical element, e.g., one (609) which is temperature-controlled with a channel (208) through which media flow.

### CROSS-REFERENCE TO RELATED APPLICATIONS

This is a Continuation of International Application PCT/EP2024/065995 which has an international filing date of Jun. 10, 2024, and the disclosure of which is incorporated in its entirety into the present Continuation by reference. This Continuation also claims foreign priority under 35 U.S.C. § 119 (a)-(d) to and also incorporates by reference, in its entirety, German Patent Application DE 10 2023 206 431.6 filed on Jul. 6, 2023.

### FIELD

The invention relates to an apparatus for thermally treating a body to be thermally treated, in particular for thermally connecting a first partial body to a second partial body to form a composite body, further particularly for high-temperature bonding. The invention furthermore relates to a method for thermally treating a body to be thermally treated, in particular for thermally connecting a first partial body to a second partial body to form a composite body, further particularly for high-temperature bonding, at an interface formed between the first partial body and the second partial body. Furthermore, the invention relates to an optical element, in particular a reflective optical element for reflecting extreme ultraviolet (EUV) radiation, furthermore in particular an element temperature-controlled with a channel through which media flow, in particular an element temperature-controlled with a channel through which media flow, further particularly an optical element temperature-controlled with a channel through which media flow, further particularly a reflective optical element temperature-controlled with a channel through which media flow. Furthermore, the invention relates to a semiconductor technology apparatus having at least one optical element, further particularly a reflective optical element which is temperature-controlled by one of the temperature-control devices with a channel, further particularly a projection exposure apparatus for EUV semiconductor lithography or a mask inspection apparatus or a wafer inspection apparatus.

### BACKGROUND

In microlithography, microstructured and nanostructured elements are for example produced as integrated circuits, wherein the structuring properties are defined by irradiation of a substrate with a directed radiation source that for example utilizes light. To this end, use is made of projection exposure apparatuses in particular which inter alia comprise a radiation source, an illumination system, a photomask (known as a reticle) and a projection system. Such partial systems of a projection exposure apparatus are in each case constructed from separate optical units which, starting from a radiation source, initially transmit the radiation used for the lithography via an illumination system to a photomask and which, from there, generate a corresponding image of the photomask on a photosensitive layer of the substrate with the projection system. The photosensitive layer can be a photoresist, and the substrate can be a silicon wafer.

In order to be able to generate the smallest possible structures on a substrate with microlithography in projection exposure apparatuses, equipment has been utilized for several years that uses particularly short-wave light from the so-called extreme ultraviolet (EUV) wavelength range with wavelengths between 0.1 nm and 30 nm, in particular 13.5 nm, as radiation. For such radiation, it is not possible to use transmission optics units in a beam path of a projection exposure apparatus consisting of multiple units on account of the inherent radiation absorption of matter in this wavelength range. Therefore, in the case of EUV radiation, only reflection optics units, for example mirrors, are used. In order to continually reduce the structural size of integrated circuits, projection exposure apparatuses that use optical elements with large numerical aperture (high-NA) or with very large numerical aperture (hyper-NA) have recently been proposed or entered production. As the numerical aperture increases, the surface of an optical element required and used to reflect the radiation becomes correspondingly larger.

### SUMMARY

Elements, in particular optical elements, further particularly reflective optical elements, for use in EUV semiconductor lithography in a projection exposure apparatus, e.g. EUV mirrors, need to withstand high thermal loads since the EUV radiation sources in the projection exposure apparatuses for EUV semiconductor lithography emit EUV radiation with high radiant power, and some of this radiant power is absorbed by the reflective coating of the optical element. The thermal energy is accordingly transferred to all elements in direct or indirect contact with the optical element. This effect leads to heating of all elements in direct or indirect contact with the optical element, and these elements may in turn lead to deformations of the optical elements within a projection exposure apparatus for EUV semiconductor lithography. In the beam path of a projection exposure apparatus for EUV semiconductor lithography there must be no time-variable and uncontrollable changes in the shape of the optical elements, or other elements, since such an effect leads to corresponding wavefront changes in the EUV radiation reflected by the optical elements. In order to counteract an operationally caused temperature change of the optical elements within a semiconductor lithography apparatus, temperature-controlled optical elements are proposed for use in such fields of application. The temperature control is, on the one hand, heating, for example to ensure a defined operating temperature before the wafer is irradiated, and, on the other hand, cooling serving to dissipate an amount of energy introduced into an optical element by way of the radiation. Such elements, in particular such optical elements, are disclosed e.g. as water-cooled mirrors in [DE102019405265A1], in which channels within the mirror substrate are used for cooling the mirrors, with a temperature-controlled fluid for cooling the substrate of the mirror flowing in these channels. The materials used for the substrates of the elements have sufficient thermal conductivity such that the thermal energy introduced by the irradiation is distributed within the substrate and dissipated from the substrate by way of fluid, in particular water, flowing in the channels within the substrate.

Such elements, in particular optical elements, for applications in the field of semiconductor lithography are manufactured from e.g. monolithic substrates or alternatively produced from two or more partial bodies. In the latter case, the individual partial bodies of an optical element, for example of a mirror substrate, are bonded to one another to form a composite body at a high temperature (between 750° C. and 1500° C.) by way of a thermal treatment, in particular through a method of high-temperature bonding. For example, partial bodies may be arranged vertically on top of one another and subsequently be thermally bonded such that the composite body is composed of at least two layers of original partial bodies. Partial bodies may also be arranged laterally next to one another and subsequently be thermally bonded such that the composite body is composed of a plurality of segments. Subsequently, the composite body is processed in a chemical and/or physical processing method into a form for its later use. This may be a substrate for an optical element, for example a mirror or a lens element. In this case, a partial region of the composite body in particular is converted into a form containing a region that comprises the subsequent optical surface of the optical element. This surface is planar, convex, concave or in the form of a free-form surface. An element produced in this way can likewise be a substrate with a mechanical use in the field of semiconductor lithography, for example a mirror, wafer or reticle receiving device.

If, following the thermal treatment of a body, for example a monolithic substrate, or of a composite body, but in particular following high-temperature bonding of a first partial body and of a second partial body to form a composite body, different expansion states \tilde{∈}₁ or \tilde{∈}₂ and hence density states of individual partial regions of a monolithic body, or of the individual original first partial bodies and second partial bodies with respective heights h₁ and h₂ of a composite body, have been frozen-in during a cooling process of the hot body or composite body due to the formation of temperature inhomogeneities in different spatial directions, then the body or composite body curves, forming a three-dimensional elastic stress profile with the curvature

$$κκ = \frac{6 {h}_{1} {h}_{2}}{{( {h}_{1} + {h}_{2} )}^{3}} ( {\tilde{ϵ}}_{1} - {\tilde{ϵ}}_{2} )$$

until the free energy F per unit area A becomes minimal as in a leaf spring with Young's modulus E and Poisson's ratio v

$$\frac{F}{A} = \frac{E}{1 - v} {h}_{1} {h}_{2} \frac{{h}_{1}^{3} + {h}_{2}^{3}}{{( {h}_{1} + {h}_{2} )}^{4}} {( {\tilde{ϵ}}_{1} - {\tilde{ϵ}}_{2} )}^{2}$$

Hence, a density jump forms in such a process, with a subsequent density gradient in at least one spatial direction.

The free energy decreases further if for example a weak joint—a so-called bond—which is formed between individual partial bodies of a composite body starts to flow, with the stored energy being converted into friction. The same effect occurs in the case of a monolithic substrate, for example on conceptually individual, infinitesimally small volume elements of the monolithic substrate. The dissipation depends on the unknown viscosity η as a function of the unknown thickness d of the bond of a composite body

$$\frac{d}{dt} F + η \cdot d \int \int {( \frac{d γ}{dt} )}^{2} dxdy = 0$$

In the process, the bond is increasingly sheared with γ toward the outside as the radius r grows as soon as the first partial body and the second partial body relax.

$$\frac{d γ}{dt} \cdot d = \frac{d ( {ϵ}_{1} - {ϵ}_{2} )}{dt} \cdot r$$

This results in an exponentially decaying drift with a characteristic time constant t toward the stress-free, stationary state.

$$τ = \frac{( 1 - v ) η}{Ed} \cdot \frac{2 I}{A} \cdot \frac{{( {h}_{1} + {h}_{2} )}^{4}}{4 {h}_{1} {h}_{2} ( {h}_{1}^{3} + {h}_{2}^{3} )}$$

which depends not only on the thickness d but also on the second moment of area I of the bond surface A.

The described overall bending of the body or of the composite body in comparison with the original state of the partial bodies is on the order of hundreds of micrometers and depends on the size of the body or of the composite body, with the bending increasing with increasing size and area of the mirror. In this case, the conceptually separated regions of the body, in particular the bond in the case of a composite body, are subject to an increasing shearing force action, as seen from the interior of the body or of the composite body toward the outside, for as long as the conceptually separated regions of the body or the first partial body and the second partial body of the composite body expand or shrink. Usually, such thermally treated bodies or bonded composite bodies drift at rates of a few picometers per year. This drift effect significantly reduces a use of substrates produced in this way in the production of mirrors in an application in the field of EUV semiconductor lithography.

However, it is possible to obtain low-stress states of a temperature-conditioned body or of a composite body, specifically when the desired distortion state can be derived as a tensor \tilde{ε} from a deformation field u:

$$\tilde{ε} = \tilde{ϵ} ( r ) 1 = \frac{1}{2} gradu + \frac{1}{2} {gradu}^{T} .$$

These Saint Venant's compatibility conditions cannot be satisfied for a general tensor distribution \tilde{∈}(r). However, there is a solution for the case of a linear density profile

$$\tilde{ϵ} ( x , y , z ) = κ \cdot z$$

specifically

$${u}_{x} = κ \cdot xz$$

$${u}_{y} = κ \cdot yz$$

$${u}_{z} = \frac{1}{2} κ \cdot ( {z}^{2} - {x}^{2} - {y}^{2} )$$

In such a case, a first partial body and a second partial body for example bend in the same way at the common contact surface, and so forming a bond between the first partial body and the second partial body does not cause any stresses. Therefore, the aim is to produce a linear profile of the described frozen-in strain states ϵᵢ by virtue of a temperature-conditioned body being forced to cool only in one spatial direction and a constant temperature gradient forming within the body in the process. The same effect also occurs between individual partial regions of a temperature-conditioned monolithic body without a region of a bond produced by a connection method being present.

The technical review article from Schott AG describes the thermally induced inherent stress in glass bodies and the effect thereof on optical properties of the corresponding glass bodies (“Stress in optical glass”, July 2004, pp. 1-13, https://www.schott.com/shop/medias/schott-tie-27-stress-in-optical-glass-eng.pdf?context=bWFzdGVyfHJvb3R8NjkzNjA5fGFwcGxpY2F0aW9uL3BkZnxoYWMv aGViLzg4MTc0MDkONTgyMDYucGRmfGY5ODdhODU3MjU4ZGNjNTc3MDIxOGJIYTY 4OTY3NTA2MGQ4ZDg0NWJjMjE5N2E0MjkxMzgONDYxM2U0ZjJhM2U, retrieved on 01.26.2023).

[U.S. Pat. No. 11,028,006B2] describes the annealing of doped TiO₂/SiO₂ mixed glasses having great homogeneity in the thermal expansion of the glasses with doping using specific chemical materials and a targeted choice of thermal and temporal parameters.

[DE102019205265A1] describes a method for producing an EUV mirror from a glass body as a composite body, wherein the composite body is produced from a first partial body and a second partial body by high-temperature bonding, and wherein a channel used to cool the mirror is formed in the composite body being produced from a structure in a surface of one of the partial bodies and by stabilization elements in the structure.

Overall, the solutions known in the prior art do not meet the high demands placed on the production of low-stress bodies, in particular on the production of low-stress composite bodies made from at least two partial bodies, by thermal treatment, wherein the body or the composite body may be configured with channels. Furthermore, the solutions known in the prior art do not meet the high demands in relation to the geometric configuration of interfaces between at least two partial bodies of a composite body and the occurrence of temperature inhomogeneities within a body during a temperature-control method or within a composite body during the high-temperature bonding.

One object addressed by the present invention is that of overcoming the disadvantages of the prior art such that bodies or composite bodies having as little stress as possible can be produced, such that the body or the composite body serves as a substrate for the production of an element, in particular an optical element and further particularly a mirror for reflecting EUV radiation, and such that the element is serviceable as a component in a semiconductor technology apparatus.

According to one formulation, this and further objects are an apparatus, a method and an element, in particular an optical element, further particularly a reflective optical element and furthermore by a semiconductor technology apparatus having the features of the independent claims. Further advantageous configurations of the invention are the subject matter of the dependent claims and also of the exemplary embodiments of the invention described hereinafter.

In the explanations that follow, numerals such as “one” do not necessarily refer to a restriction to precisely one partial body, one composite body, one jacket, one element, one component, one method and/or the like. Instead, multiple partial bodies, composite bodies, jackets, elements, components, methods and/or the like, for example two, three or more, may also be provided. Any other numeral used here should also not be interpreted to the effect that there is a restriction to exactly the stated number of partial bodies, composite bodies, jackets, elements, components or methods. Rather, unless indicated otherwise, numerical deviations upward and downward are possible.

Further possible implementations of the invention also comprise combinations not explicitly mentioned of features or embodiments described hereinabove or hereinafter with regard to the exemplary embodiments. A person skilled in the art will also add individual aspects as improvements or supplementations to the respective basic form of the invention.

For the sake of simplicity, the phrase thermal treatment is used below as a generic term of a procedure according to the invention and hence comprises a high-temperature bonding method by definition. Furthermore, the phrase a body to be thermally treated is used below as a generic term of all arrangements of bodies according to the invention for thermal treatment and hence comprises a monolithic body, a composite body, a first partial body and/or a second partial body and an arrangement of a first partial body and a second partial body by definition.

An apparatus according to the invention for thermally treating a body to be thermally treated comprises a jacket, a temperature-controllable space within a temperature-control unit and a heating element. The apparatus also comprises a control unit in a variant of the invention. In a further variant of the invention, the apparatus furthermore comprises an air circulation unit. Moreover, a medium or vacuum is present in the temperature-controllable space within a temperature-control unit. The apparatus according to the invention is characterized in that the jacket contactlessly surrounds the body to be thermally treated before, during and after the thermal treatment, and the jacket consists of the same material as the body to be thermally treated. According to the invention, the jacket advantageously fulfills the task of an insulation body which renders an advantageous temperature distribution for stress-free high-temperature bonding possible in the interior of the body to be thermally treated.

As a result of the jacket consisting of the same material as the body to be thermally treated, it is possible to easily take account of changes in the shape of the jacket and the body to be thermally treated which are induced by a change in temperature, and there are no material-induced changes in the heat flow.

In a variant, the temperature-control unit of the apparatus is a furnace, preferably an annealing furnace. The temperature-control unit is designed to achieve temperatures for thermal treatment, in particular for annealing glass substrates and/or performing a method of high-temperature bonding, and maintain these temperatures at a constant level over a period of time.

In a further embodiment, the apparatus according to the invention is characterized in that on the outside the jacket assumes the shape of a cylinder. In this case, the cylinder is of ellipsoidal configuration, i.e. the cross section of the cylinder has a numerical eccentricity in a range from 0 to 0.1, preferably an eccentricity of less than 0.05 and further preferably an eccentricity of less than 0.01. In this case, a usable eccentricity of the jacket depends on an inhomogeneity of the temperature distribution in the interior of a temperature-control unit, with the usable eccentricity becoming smaller as the inhomogeneity of the temperature distribution in the interior of the temperature-control unit increases. An eccentricity of up to 0.1 is usable for a maximum temperature difference of no more than 25 K in the interior of a temperature-control unit. An eccentricity of up to 0.01 is usable for a temperature difference of no more than 250 K in the interior of a temperature-control unit.

It is possible that the jacket cylinder is arranged at an oblique position with respect to the surrounded body to be thermally treated. The angle depends on the temperature differences and the aspect ratio of the body. In the case of an aspect ratio of height to diameter of 1:10 and a temperature difference of 250 K, the jacket may be inclined up to an angle of 0.1 rad. The same applies to the opening angle when the jacket deviates conically from the ideal cylindrical shape.

In a variant of the invention, the jacket is open on at least one side. In this case, an outer approximately cylindrical shape of the jacket advantageously supports the formation of a constant temperature gradient along an axis of the jacket, in particular along the longitudinal axis of the cylindrical jacket, and a homogeneous profile of the temperature distribution along the cylinder radius. In a further variant of the invention, it is also advantageous for the jacket to be at least as high as the body to be thermally treated. The use of this embodiment supports, to the best possible extent, the formation of a constant temperature gradient along the longitudinal axis and a homogeneous profile of the temperature distribution along the radius of the cylindrical arrangement composed of the jacket and of the body to be thermally treated. Depending on a temperature distribution and thermal movement within a medium in the space that is temperature controlled by the temperature-control unit, the jacket according to the invention continuously continuing the top side or lower side of the body to be thermally treated is furthermore advantageous in order to minimize a local temperature gradient, for example within an arbitrary sectional plane of constant height of the body to be thermally treated.

In a variant of the invention, the wall thickness of the jacket is at least one tenth and at most ten times the height of the body to be thermally treated; preferably, however, the diameter of the entire arrangement composed of the jacket and the body to be thermally treated is the same as the height of the same arrangement.

The jacket is arranged as close as possible to the body to be thermally treated such that a local temperature gradient formed in the interior of the body to be thermally treated, for example within an arbitrary sectional plane of constant height, is advantageously suppressed to the best possible extent following the thermal treatment and there simultaneously is no physical contact between the jacket and the body to be thermally treated, this physical contact being caused by a change in shape of the jacket and/or the body to be thermally treated as a result of thermal expansion.

In a further embodiment of the apparatus according to the invention, each surface of the jacket facing a surface of the body to be thermally treated has at least a distance of 0.1 mm and at most a distance of 30 mm from the body to be thermally treated. This allows reuse of the jacket following the thermal treatment. It is furthermore advantageous if the distance between the jacket and the body to be thermally treated is constant along a complete circuit of the body to be thermally treated. A further advantage of such an embodiment lies in the fact that the outer contour of the body to be thermally treated is not subject to any shape restriction for as long as the jacket is suitable for contactlessly surrounding, in the above-described manner, the body to be thermally treated. In a variant of the invention, the body to be thermally treated has e.g. a polygonal or an oval perimeter. In further variants of the invention, the body to be thermally treated has any desired free-form perimeter.

In a further advantageous embodiment of the apparatus according to the invention, the body to be thermally treated comprises an amorphous silicon-containing glass and/or a semicrystalline ceramic. The use of materials having a very good or excellent thermal conductivity is advantageous for the body to be thermally treated such that temperature distributions in the interior of the body to be thermally treated equilibrate as quickly as possible after a change in temperature during the high-temperature bonding, and heat situated in the body to be thermally treated can be conducted as quickly as possible to a surface and released into a medium in the surroundings or directly to a furnace wall.

In a further advantageous embodiment of the apparatus according to the invention, the body to be thermally treated comprises a titanium-doped quartz glass. Titanium-doped quartz glass has an extremely small coefficient of thermal expansion in the region of a zero-crossing temperature. As a result, titanium-doped quartz glass is suitable as substrate material for an EUV optics unit since approximately no deformation of the substrate material that may have a negative effect on the imaging properties is expected during operation in the region of the zero-crossing temperature.

In this case, the usability of materials for the jacket with chemical compositions that deviate slightly from the material of the body to be thermally treated depends on the similarity of the thermal conductivity of the material of the jacket in comparison with that of the material of the body to be thermally treated. In this case, the thermal conductivity of the jacket may deviate by no more than one tenth of the thermal conductivity of the material of the body to be thermally treated from the thermal conductivity of the material of the body to be thermally treated, preferably by no more than one twentieth and further preferably by no more than one hundredth.

A method according to the invention for thermally treating a body to be thermally treated with the apparatus according to the invention described further above comprises the following steps: providing at least one body to be thermally treated, arranging the at least one body to be thermally treated and the jacket in the temperature-controllable space with the medium of the apparatus according to the invention, such that the jacket contactlessly surrounds the at least one body to be thermally treated, and thermally treating the body to be thermally treated.

During the thermal treatment, the at least one body to be thermally treated is typically heated to a temperature between 75° and 1500° C. As a result, for example, the respective surfaces of the partial bodies to be connected during the thermal treatment are materially bonded to one another without the use of a joining arrangement.

In an embodiment of the method according to the invention, the body to be thermally treated is formed from amorphous silicon-containing glass and/or from a semicrystalline ceramic.

In an embodiment of the method according to the invention, the body to be thermally treated is formed from titanium-doped quartz glass. As regards the advantages of amorphous silicon-containing glass, semicrystalline ceramics and titanium-doped quartz glass, reference is made to the description above.

In an embodiment of the method according to the invention, the at least one body to be thermally treated is processed on a surface by a chemical and/or physical processing method before or after the thermal treatment. In a variant of the invention, this for example relates to a cleaning method in which one or more surfaces of the body to be thermally treated are cleaned. In a further variant, this for example relates to a shaping method in which one or more surfaces of the at least one body to be thermally treated are provided with a shape. In a first aspect, a physical processing method is a machining method in which material is removed from one or more surfaces of the body to be thermally treated, and the shape of the processed surface is modified as a result. In a further aspect, this for example relates to a polishing method in which one or more surfaces of the at least one body to be thermally treated are polished to a target value of a surface roughness. In a further aspect, this for example relates to an erosion method. In a further aspect, this for example relates to a chemical etching method in which material is removed from one or more surfaces of the at least one body to be thermally treated, and the shape of the processed surface is modified as a result. In a further aspect, this for example relates to a coating method, for example chemical vapor deposition, sputtering, atomic layer deposition, pulsed laser deposition or an electroplating method. In a further aspect of the invention, two or more of the described methods are carried out sequentially.

In a further embodiment of the method, an interface between the first partial body and the second partial body is for example formed as a planar interface. In a further variant, the interface is formed as a concave or convex interface. In a further variant of the method, the interface is formed as a free-form surface.

Since the at least one body to be thermally treated may deform during a temperature change from a state at room temperature at the outset to a state at a temperature during the high-temperature bonding, such a temperature-induced change in shape is advantageously taken into account in the shapes of the at least one body to be thermally treated and kept available in a chemical and/or physical processing method that precedes the thermal treatment. Accordingly, the expected temperature-induced change in shape of the at least one body to be thermally treated is advantageously taken into account in the design of the jacket shape and kept available such that the jacket does not establish any direct physical contact with the at least one body to be thermally treated.

On a first surface of the at least one first partial body, a first structure made of at least one groove and at least one ridge is formed on the first surface of the at least one first partial body by chemical and/or physical processing of the surface in a further embodiment of the method according to the invention. On a second surface of e.g. the second partial body, a second structure made of at least one groove and at least one ridge is formed on the second surface of the second partial body by chemical and/or physical processing in a variant of the method. For example, when performing high-temperature bonding of the first partial body and the second partial body to form a composite body, at least one continuous channel is formed according to the invention in the interior of the composite body at an interface, which is formed by the first surface of the first partial body and the second surface of the second partial body, of the structure situated on the first surface of the first partial body and/or the structure situated on the second surface of the second partial body, with parts of the at least one continuous channel and/or parts of different multiple continuous channels being formed so as to be separated from one another by ridges. The at least one channel of this type is for example formed as a spiral, in meandering fashion, linearly, in a manner bent toward the center of the composite body or bent outward, or else as a pseudo-two-dimensional network. In a variant, the at least one channel of this type has at least one symmetry element. The ridges which separate parts of the at least one channel or of multiple individual channels from one another have the same or different ridge widths and ridge shapes when considered over the entire surface. The at least one channel is round in one variant. In a further variant, the channel is oval. In a further variant, the channel comprises at least one polygonal structure and/or at least one rounded-off structure. The at least one continuous channel thus configured in the interior of the composite body is advantageously used to guide gaseous and/or liquid media at a defined temperature through the composite body and to control the temperature of the material of the composite body by heat transfer between the medium and the composite body.

The production of predefined structures thus configured on the surfaces of a first partial body and/or of a second partial body is implemented according to the invention by machining methods such as milling, turning or drilling. In a variant of the method, a predefined structure is alternatively produced by a chemical processing method, for example an etching method. In a further variant, the method for producing the channel structure in a partial region of the partial body comprises irradiation with electromagnetic radiation. In a further variant, the at least one channel is produced by an ablation method, for example with laser radiation or with electron radiation or with ion radiation. The grooves in the structured surfaces used to produce the at least one channel are configured with flat surfaces or surfaces provided with a curvature. In a variant of the method, at least two of the aforementioned methods are applied successively in order to produce the predefined structures in the surfaces of the first partial body and/or of the second partial body. In this variant, the nature of the surface of the predefined structures is advantageously set after the application of a first method step. In a variant of the invention, the surface roughness has RMS values of no more than 10 micrometers, in particular of no more than 5 micrometers and further particularly of no more than 2 micrometers.

In a further embodiment of the method, a multiplicity of partial bodies are combined by a thermal treatment, in particular high-temperature bonding, to form a composite body (stack-sealing method), with a first partial body and a second partial body from the multiplicity of partial bodies in each case contacting each other at at least one interface. To produce a composite body having at least one internal channel, predefined structures on at least one surface of the partial body, or partial bodies, are advantageously present in a first partial body, in a second partial body or in a multiplicity of partial bodies, these predefined structures in each case connecting to form the at least one channel within the composite body as a result of the composite body being formed.

In an embodiment of the method, the first partial body and the second partial body are connected to one another by optical contact bonding such before the high-temperature bonding starts that the optical contact bonding surface corresponds to the interface at which the first partial body is connected to the second partial body in order to form a composite body. If a multiplicity of partial bodies are used to form a composite body, the individual partial bodies of the multiplicity of partial bodies are also connected to each other by optical contact bonding before the start of the high-temperature bonding in a variant of the method, whereby the at least one optical contact bonding surface between a first partial body and a second partial body corresponds to the at least one interface at which at least one first partial body is connected to at least one second partial body in order to form a composite body.

A further embodiment of the method according to the invention is characterized in that within the body to be thermally treated a first local temperature of an arbitrary first infinitesimal area element within an arbitrary first sectional plane of a first constant height of the body to be thermally treated and a second local temperature of an arbitrary second infinitesimal area element within the same first sectional plane of constant height of the body to be thermally treated differ by no more than 1 K. According to the invention, an effect of the insulating mode of action of the jacket is that a local temperature gradient is minimal, albeit not completely suppressed, within the arbitrary sectional plane of constant height of this kind. Furthermore, the method according to the invention is characterized in that the first local temperature of the arbitrary first infinitesimal area element within the arbitrary first sectional plane of the first constant height of the body to be thermally treated and a third local temperature of an arbitrary third infinitesimal area element within an arbitrary second sectional plane of a second constant height of the same body to be thermally treated have a non-zero temperature difference. Thus, in such a method, a local temperature gradient advantageously forms according to the invention between the arbitrary first sectional plane of the first constant height and the arbitrary second sectional plane of the second constant height as a result of a structure that is open at least on one side in the jacket surrounding the body to be thermally treated, this local temperature gradient leading to heat diffusion from a warm point in the interior of the body to be thermally treated to a surface of the body to be thermally treated. This heat diffusion is advantageously used for cooling the body to be thermally treated.

A further embodiment of the method according to the invention is characterized in that within the body to be thermally treated, starting from the arbitrary first infinitesimal area element with the first local temperature within the arbitrary first sectional plane of the first constant height, the gradient of a first local temperature profile at an arbitrary height of the body to be thermally treated, the gradient being along a first normal of the arbitrary first sectional plane of the first constant height toward the arbitrary third infinitesimal area element with the third local temperature within the arbitrary second sectional plane of the second constant height, differs by no more than 5% from an averaged temperature gradient which is calculated over a corresponding temperature profile over the entire height of the body to be thermally treated. The first local temperature profile of this kind between the arbitrary first infinitesimal area element and the arbitrary third infinitesimal area element always causes a local density gradient and a density profile on account of the thermal expansion of the material of the body to be thermally treated. Since a temperature profile formed in this way in the interior of the body to be thermally treated accordingly has an approximately linear configuration, a density profile may also have an approximate linear profile. In an aspect of the invention, the at least one density gradient exists along an axis of symmetry of the body to be thermally treated, in particular in the direction of gravity. In a further aspect, the at least one density gradient exists in parallel with the gravitational force of the body to be thermally treated.

Over a large temperature range, an approximately linear temperature profile may cause a nonlinear density profile within the body to be thermally treated. In this case, a temperature difference according to the invention is advantageously more than 5 K but less than 500 K along the temperature profile within the body to be thermally treated.

Furthermore, a method according to the invention is characterized in that, starting from the arbitrary second infinitesimal area element with the second local temperature within the arbitrary first sectional plane of the first constant height, the gradient of a second local temperature profile at an arbitrary height of the body to be thermally treated, the gradient being along a second normal of the arbitrary first sectional plane of the first constant height toward an arbitrary fourth infinitesimal area element with a fourth local temperature within the arbitrary second sectional plane of the second constant height, differs by no more than 5% from an averaged temperature gradient which is calculated over a corresponding temperature profile over the entire height of the body to be thermally treated, the temperature gradient averaged over the first local temperature profile and the temperature gradient averaged over the second local temperature profile differing by no more than 5% from each other. This is advantageous in order to ensure an approximately homogeneous heat transport within the body to be thermally treated, as seen over the arbitrary first sectional plane of the first constant height and/or the arbitrary second sectional plane of the second constant, and to avoid mechanical stresses, in particular at the bond of the composite body formed in the case of the high-temperature bonding of a first partial body to a second partial body. This is necessary since different local temperatures within conceptually finite area elements of the body to be thermally treated are translated into locally different thermal expansions and locally different material densities. Should three-dimensional finite volume elements within the body to be thermally treated be strung together in a seamless manner, no stresses arise in theory within the body to be thermally treated, especially in the region of the interface of the composite body. This is the case when there is a linear profile of an isotropic distortion within the body to be thermally treated that is caused by a spatially homogeneous temperature gradient within the body to be thermally treated. In such a case, two conceptually separated finite volume elements bend in the same way at a common interface within a body to be thermally treated, and so no stresses due to a change in shape occur, especially not when joining finite volume elements of a body to be thermally treated. In the latter case, no temporal drift arises after the high-temperature bonding, for example after the bond is formed due to slow stress relaxation. Thus, minimized stresses occur within the body to be thermally treated in the general case, for as long as Saint Venant's compatibility condition is observed.

Thus, according to the invention, it has been recognized overall that a jacket is advantageously used to allow a stress-free thermal treatment of a body to be thermally treated, for example for stress-free production of a composite body by high-temperature bonding. The jacket makes it possible to form, following the thermal treatment, a spatially homogeneous unidirectional temperature profile within the body to be thermally treated. Furthermore, the jacket enables low-stress cooling of the body to be thermally treated, especially of the bond following the high-temperature bonding. A unidirectional temperature profile according to the invention during the cooling of the body to be thermally treated advantageously leads to an increased dimensional stability of the body to be thermally treated, in particular of the bond within the composite body produced by high-temperature bonding.

In a further embodiment of a method according to the invention, the thermal treatment of the body to be thermally treated comprises, as temperature profile phases, a heating phase starting from a first temperature to a second temperature, during which the at least one body to be thermally treated is heated with a temporal heating temperature ramp, a holding phase, during which the at least one body to be thermally treated is heated at the approximately time-constant second temperature, and a cooling phase starting from the second temperature to the first temperature or a third temperature, during which the at least one body to be thermally treated is cooled with a temporal cooling temperature ramp.

In a variant of the method, all method steps or only selected method steps are performed in an inert gas atmosphere, e.g. an atmosphere of argon or nitrogen. During the heating phase, the at least one body to be thermally treated and the jacket are heated to a temperature above a lower cooling point. During the holding phase, the at least one body to be thermally treated, for example the first partial body and the second partial body, are annealed in a manner provoking targeted low-stress distortions and are connected to each other at an interface. Residual stresses of no more than 1 kPa-1 MPa are formed in the process. A density gradient caused by a temperature gradient advantageously has absolute values of at least 3 ppm/m. Since the degree of crystallization of the material of the composite body likewise depends on the temperature, this may also lead to the formation of different degrees of crystallization and optionally to different crystallization states in the form of thermodynamic phases of the material in the direction of the temperature gradient. In an aspect of a method according to the invention, the degree of crystallization advantageously changes by more than 5 ppm/m but not by more than 10% over the body to be thermally treated.

According to the invention, the time-constant temperature set during a holding phase is above an annealing point of the material of the body to be thermally treated, preferably above the glass temperature of the material of the at least one body to be thermally treated, for example at more than approx. 600° C., as a rule between approx. 800° C. and 1500° C. and preferably between 900° C. and 1200° C. In an advantageous variant of the method, the duration of the holding phase is less than ten weeks, advantageously less than six weeks and further advantageously less than four weeks.

In the body to be thermally treated and in the jacket, a cooling temperature ramp is applied with a temporally non-linear profile using the temperature-control unit and a medium in a further embodiment of the method according to the invention. A form of application according to the invention uses temperature ramps with continuous profiles. The total duration and the temporary gradients of real temperature ramps depend greatly on various parameters of the embodiment and must be ascertained approximately with finite element calculations. Essential parameters that should be mentioned are the number, the geometry and the dimensions of the body to be thermally treated and of the jacket, the material of the body to be thermally treated and of the jacket, and the phase diagram thereof with any phase transitions occurring in the utilized temperature and pressure range, and also characteristic material properties such as the density, the heat capacity, the thermal conductivity, the hardness or the ductility of the material used. Attention is drawn to the fact that the above list should not be construed as exhaustive and further common material properties are used to ascertain and predict a temporal temperature ramp with the finite element method. For a mass in the case of a cylindrical geometry of the at least one body to be thermally treated and/or of a jacket of 3-5000 kg and in the case of a radius and a cylinder height of 10-300 cm, linearly approximated temperature changes in infinitesimal temperature intervals of the temperature ramps, in comparison with the overall duration of a ramp, are 0.1-10 K/h if use is made of TiO2-doped silicate glasses as material for the at least one body to be thermally treated and/or the jacket.

Since local differences in the temperature gradients within the arbitrary first sectional plane of the first constant height and/or the arbitrary second sectional plane of the second constant height of a body to be thermally treated are not perfectly suppressed by the jacket, as described above, a further aspect of the invention proposes a method enhancement in order to further minimize residual inhomogeneities of the temperature gradients within the arbitrary first sectional plane of the first constant height and/or the arbitrary second sectional plane of the second constant height of the body to be thermally treated.

In a further embodiment of the method according to the invention, the cooling temperature ramp comprises a superposition of the following components: a first component having a continuously falling temperature profile starting from a first temperature to a second temperature, with a cooling rate that can be set in each case with the control unit, a first temperature and a second temperature and a second component having a periodic temperature change starting from a third temperature to a fourth temperature with a third temperature that can be set in each case with the control unit, a fourth temperature, an amplitude, a period, a phase and an attenuation and/or an amplification. The aforementioned parameters of the periodic temperature change of the temperature ramp depend greatly on various parameters of the embodiment, may be time variable and must also be ascertained approximately with finite element calculations. Essential parameters that should be mentioned here likewise are the number, the geometry and the dimensions of the bodies to be thermally treated and of the jacket used, the material of the bodies to be thermally treated and of the jacket, and the phase diagram thereof with any occurring phase transitions in the utilized temperature and pressure range, and also characteristic material properties such as the density, the heat capacity, the thermal conductivity, the hardness or the ductility of the material, wherein this list is also not exhaustive and further material properties may be used. Simple considerations give rise to benchmarks for the amplitude and the period of the oscillation as a function of the thermal conductivity constant and the geometry of a substrate. For a mass of the at least one body to be thermally treated and/or of a jacket of 3-5000 kg and in the case of a radius and a cylinder height of 10-300 cm, linearly approximated temperature changes in infinitesimal temperature intervals of the temperature ramps, in comparison with the overall duration of a ramp, are 0.1-10 K/h if use is made of titanium-doped silicate glasses as material for the at least one body to be thermally treated and/or the jacket.

In a variant of the embodiment of the method according to the invention, the period of the time-periodic component of the temperature ramp is chosen such that the amplitude of the thermal waves close to the center of mass of the at least one body to be thermally treated and of the jacket are attenuated to less than half in comparison with the amplitude of the periodic changes in temperature of the surrounding medium. In this case, the period advantageously assumes values between 1 s and 1 month.

In a further advantageous embodiment of the method according to the invention, the cooling temperature ramp is used to generate a temperature distribution within the body to be thermally treated, this temperature distribution being characterized within the arbitrary first sectional plane of the first constant height of the body to be thermally treated by a first spatial temperature profile at an arbitrary first time and a second spatial temperature profile at a second time, wherein the second time is temporally shifted relative to the arbitrary first time by half a period of the second component of the cooling temperature ramp, and wherein the first spatial temperature profile at the arbitrary first time has an at least partially inverted profile relative to the second spatial temperature profile at the second time. In a variant of the method, the first spatial temperature profile and the second spatial temperature profile are approximately parabolic temperature profiles along the coordinates of the arbitrary first sectional plane of constant height.

Naturally, the amplitude of the time-periodic component of the temperature ramp of the temperature-control unit and that of the medium surrounding the composite body exceeds the maximum attainable temperature difference close to the center of mass of the body to be thermally treated and of the jacket. Furthermore, according to the invention, the amplitude of the time-periodic component exceeds the maximum deviation of a continuously decreasing or continuously increasing component of the temperature ramp of the temperature-control unit within a time interval defined by a period. In this case the amplitude according to the invention of the time-periodic component moves in the range between 5 K and 250 K. At the start of the temperature ramp and at its end, the amplification and attenuation, respectively, of the amplitude is advantageously set so that the arising periodic component of the nonlinear temperature ramp results in its value being zero.

According to the invention, it was recognized that the formation of a unidirectional temperature profile within the body to be thermally treated, in particular after high-temperature bonding of the first partial body and the second partial body with the aid of the jacket, is assisted by an additional time-periodic modulation of the temperature ramp for cooling the at least one body to be thermally treated.

By applying the periodic modulation of this type, it is furthermore advantageously possible to reduce the duration of the cooling phase since stresses in the body to be thermally treated, averaged over the period of the time-periodic modulation of a cooling temperature ramp, are at least partially leveled, whereby, averaged over time, an overall higher cooling rate is made possible in comparison with a purely linear cooling temperature ramp.

An optical element according to the invention, especially for reflecting EUV radiation, comprises a substrate produced from a body to be thermally treated in accordance with a method according to the invention, and a reflective coating, in particular a coating reflecting EUV radiation, applied to the substrate on a surface, in particular applied by a second chemical and/or physical processing method. In this case, in an aspect of the invention, the substrate is produced from the body to be thermally treated according to the invention by a chemical and/or physical processing method on at least one surface. In a variant of the invention, this for example relates to a cleaning method in which one or more surfaces of the first partial body and/or of the second partial body are cleaned. In a further variant, this for example relates to a shaping method in which one or more surfaces of the composite body are provided with a shape. In an aspect, this for example relates to a machining method in which material is removed from one or more surfaces of the body to be thermally treated, and the shape of the processed surface is modified as a result. In a further aspect, this for example relates to a polishing method in which one or more surfaces of the body to be thermally treated are polished to a target value of a surface roughness. In a further aspect, a chemical and/or physical processing method is an erosion method. In a further aspect, this for example relates to a chemical etching method in which material is removed from one or more surfaces of the composite body, and the shape of the processed surface is modified as a result. In a further aspect, this for example relates to a coating method, for example chemical vapor deposition, sputtering, atomic layer deposition, pulsed laser deposition or an electroplating method. In a further aspect of the invention, two or more of the described methods are carried out one after the other.

In this case, the reflective coating is designed to reflect EUV radiation at a wavelength between approx. 5 nm and approx. 30 nm, in particular for reflecting radiation at a wavelength of approximately 13.5 nm (lithography) or in the range from approximately 2.3 nm to 4.4 nm (water window). In a further variant, the specific configuration of the reflective coating comprises not only the layers actually reflecting the radiation but also one or more additional layers such as e.g. absorber layers, protective layers, base layers or adhesion-promoting layers.

In an embodiment of the invention, the optical element is characterized in that at least one continuous channel, produced in accordance with a method according to the invention, is used within the substrate of the reflective optical element for active temperature-control, with liquid and/or gaseous media, of the substrate and of a reflective coating, in particular a coating reflecting EUV radiation, applied to the substrate on a surface, in particular by a chemical and/or physical processing method.

In a variant, the fluid used for active temperature control of the optical element is water, in particular high-purity water, with a conductance of <0.1 μS/cm. As a result, the reflective optical element can be actively temperature-controlled in a temperature range of approximately 0° C.-100° C. In further variants, the fluid used for active temperature control is a high-purity gaseous fluid, in particular high-purity compressed air. In a specific variant, the gaseous fluid used for active temperature control is a high-purity inert gas such as nitrogen or argon and mixtures of high-purity gases. In a further variant, the fluid used for active temperature control is a suspension of condensed CO2 and organic solvents, for example isopropyl alcohol. In a further variant, the fluid used for active temperature control is a medium analogous to that used in a heat pipe, for example low-boiling organic hydrocarbons, ammonia or alkali metals.

Such temperature-control methods are used during zero, one or multiple production step(s) for the reflective optical element following the thermal treatment according to the invention of the body to be thermally treated, and during the use according to the invention of the reflective optical element.

The material of the body to be thermally treated is for example based on silicate as base material. In further variants, one or more chemical components are added to the base material as dopants, for example titanium dioxide (TiO2). Ideally, the percentage proportion of the doping material is less than 10% by weight. Other chemical compounds with high thermal conductivity are used in further variants, as are alternative common dopings.

A semiconductor technology apparatus according to the invention is characterized in that it comprises at least one optical element according to the invention. In a variant, the semiconductor technology apparatus is an apparatus for producing structured semiconductor substrates or an apparatus for qualifying optics used in the field of semiconductor technology. In specific variants, this is an apparatus from the field of EUV semiconductor technology in particular, furthermore in particular a projection exposure apparatus for EUV semiconductor lithography of wafers or similar substrates, furthermore in particular a mask inspection apparatus for EUV semiconductor lithography and furthermore in particular a wafer inspection apparatus for EUV semiconductor lithography. In a further variant, the at least one optical element is configured with at least one continuous channel which during the operation of the semiconductor technology apparatus is used for temperature control of the reflective optical element, i.e. for cooling and/or heating the latter.

In a further variant, the body to be thermally treated is used for other purposes than for producing a (reflective) optical element. In this case, too, at least one optionally present continuous channel may be used to heat and/or cool the body to be thermally treated when a fluid flows through this channel.

Further features and advantages of the invention are evident from the following description of exemplary embodiments of the invention with reference to the figures of the drawing, which show details essential to the invention, and from the claims. The individual features can be realized in each case individually by themselves or as a plurality in any desired combination in a variant of the invention.

### BRIEF DESCRIPTION OF THE DRAWINGS

Exemplary embodiments are shown in the schematic drawings and explained in the description which follows. In the drawing:

FIG. 1 shows a schematic illustration of an apparatus according to the invention.

FIG. 2A shows a schematic illustration of a first partial body and of a second partial body, each with a surface structure.

FIG. 2B shows a schematic illustration of the body to be thermally treated using the example of a composite body.

FIG. 2C shows a schematic illustration of the body to be thermally treated using the example of a composite body.

FIG. 3A shows a schematic illustration of the body to be thermally treated using the example of a composite body with sectional planes of constant height.

FIG. 3B shows a schematic illustration of spatial temperature distributions within the body to be thermally treated.

FIG. 3C shows a schematic illustration of two spatial temperature profiles within the body to be thermally treated.

FIG. 4 shows a schematic illustration of a temporal temperature profile of a medium of a temperature-control unit during the high-temperature bonding.

FIG. 5A shows a schematic illustration of individual components of a phase of a temporal temperature profile.

FIG. 5B shows a schematic illustration of a phase of a temporal temperature profile.

FIG. 5C shows a schematic illustration of spatial temperature profiles in the interior of the body to be thermally treated, at different times during the cooling phase of the high-temperature bonding.

FIG. 6 shows a reflective optical element.

FIG. 7 shows a schematic illustration of a semiconductor technology apparatus in meridional section using the example of a projection exposure apparatus for EUV semiconductor lithography.

### DETAILED DESCRIPTION

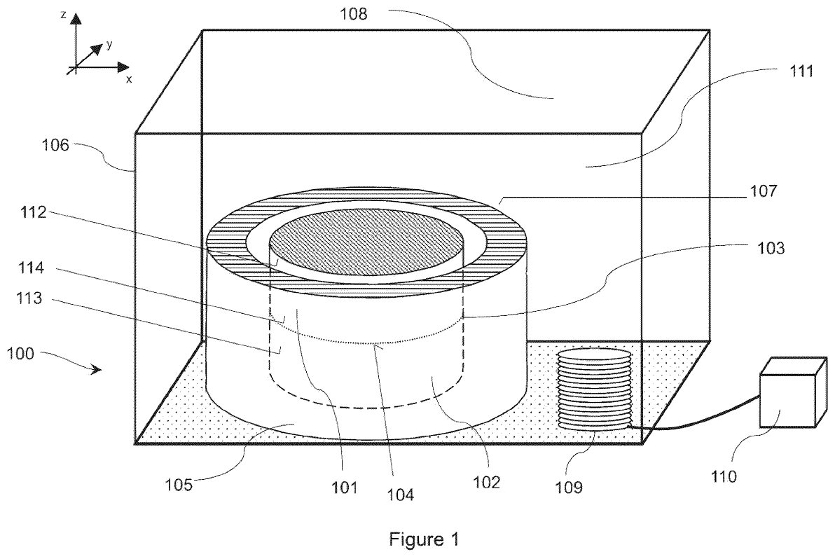

FIG. 1 shows an embodiment of an apparatus (100) according to the invention, comprising a jacket (105), a temperature-control unit (106), a heating element (109) and a medium (111) which is situated in a space (108) of the temperature-control unit (106), the temperature of which can be controlled with the heating element (109). In this case, the temperature-control unit (106) is designed such that, in the temperature-controllable space (108) with the medium (111), the jacket (105) contactlessly surrounds a body to be thermally treated, shown here using the example of an arrangement of a first partial body (101) and a second partial body (102). Using a heating element (109), the temperature-control unit (106) controls the temperature of the body to be thermally treated, which is surrounded by the jacket (105). In this variant of the embodiment, the apparatus (100) for thermally connecting the first partial body (101) to the second partial body (102) in order to form a composite body (103) is used with high-temperature bonding at an interface (104) formed between the first partial body (101) and the second partial body (102). In this case, before the high-temperature bonding is performed, the jacket (105) contactlessly surrounds an arrangement of first partial body (101) and second partial body (102) which make contact with one another at an interface (104). The jacket (105) also contactlessly surrounds the composite body (103) during and after the high-temperature bonding. The same applies to the use of the apparatus (100) for the thermal treatment of a body (101, 102, 103) to be thermally treated in the case of temperature control of a monolithic body.

In a variant of the apparatus (100) according to the invention, the apparatus (100) furthermore comprises a control unit (110). In this variant of the embodiment, the control unit (110) is configured to set the temperature of at least one of the elements in the interior of the temperature-control unit (106), preferably of all elements in the interior of the temperature-control unit (106), at at least one time during a process of thermally treating a body (101, 102, 103) to be thermally treated.

In a variant of an embodiment according to the invention, the dimensions of the jacket (105) are chosen such that each surface (107) of the jacket (105) facing a surface (112) of the body (101, 102, 103) to be thermally treated, for example facing a surface (114) of the first partial body (101) and/or a surface (113) of the second partial body (102), has a distance of at least 1 mm, preferably at least 0.1 mm, from the body (101, 102, 103) to be thermally treated. In order to ensure the function of the jacket (105) according to the invention, it is necessary to limit the distance of the jacket (105) from the body (101, 102, 103) to be thermally treated. The distance of each surface (107) of the jacket (105) facing the surface (112, 113, 114) of the body (101, 102, 103) to be thermally treated is no more than 30 mm, preferably 7 mm, more preferably 5 mm. In this case, the distance between the jacket (105) and the body (101, 102, 103) to be thermally treated is ideally constant along a complete circuit of the body (101, 102, 103) to be thermally treated such that the surface (107) follows the shape of the body (101, 102, 103) to be thermally treated. However, there is the restriction that it must be possible to remove the jacket (105) from the body (101, 102, 103) to be thermally treated following the thermal treatment without the jacket (105) or the body (101, 102, 103) to be thermally treated being mechanically damaged in the process. Likewise, the distance of each surface (107) facing the surface (112) is up to at most 10 mm, preferably 7 mm, more preferably 5 mm, during and after the thermal treatment. This dimensioning of the jacket (105) ensures that the jacket (105) is suitable for reuse after the thermal treatment.

According to the invention, the jacket (105) is configured externally in the form of a cylinder. In a variant of the invention, the cylinder is of ellipsoidal configuration, i.e. the cross section of the cylinder has a numerical eccentricity in a range from 0 to 0.1, preferably an eccentricity of less than 0.05 and further preferably an eccentricity of less than 0.01. In this case, a usable eccentricity of the jacket (105) depends on an inhomogeneity of the temperature distribution in the interior of a temperature-control unit (106), with the usable eccentricity becoming smaller as the inhomogeneity of the temperature distribution in the interior of the temperature-control unit (106) increases. An eccentricity of up to 0.1 is usable for a maximum temperature difference of no more than 25 K in the interior of a temperature-control unit (106). An eccentricity of up to 0.01 is usable for a temperature distribution of no more than 250 K in the interior of a temperature-control unit (106). According to the invention, the height of the jacket (105) is chosen such that the jacket (105) is at least as high as the body (101, 102, 103) to be thermally treated. Since the composite body (103), for example, arises during the thermal treatment in the embodiment of high-temperature bonding, the jacket (105) must also be designed to be at least as high as an expected height of the composite body (103) during and after the high-temperature bonding. In a variant of the invention, the wall thickness of the jacket (105) is at least one tenth and at most ten times the height of the body to be thermally treated; preferably, however, the diameter of the arrangement made of the body (101, 102, 103) to be thermally treated and the jacket (105) is the same as the height of the same arrangement.

On account of thermal expansion, the jacket (105) and the body (101, 102, 103) to be thermally treated undergo a change in shape during a temperature change within the scope of high-temperature bonding. The expected change in shape in the temperature range applied during the thermal treatment needs to be taken into account here for the choice of geometry of the jacket (105) relative to the body (101, 102, 103) to be thermally treated and choice of composite body (103) for example produced during the thermal treatment and needs to be kept available such that the jacket (105) has contact with the body (101, 102, 103) to be thermally treated before, during and after the thermal treatment. In order to advantageously take account of changes in shape that arise during the high-temperature bonding for the body (101, 102, 103) to be thermally treated and for the jacket (105), the individual coefficients of thermal expansion of the materials involved should be chosen to be as similar as possible and ideally the same. Therefore, the jacket (105) is advantageously manufactured from the same material as the body (101, 102, 103) to be thermally treated. This advantageously ensures that no contact between the body (101, 102, 103) to be thermally treated and the jacket (105) arises before, during and after the thermal treatment. Furthermore, this advantageously ensures that the distance between the body (101, 102, 103) to be thermally treated and the jacket (105) has spatially homogeneous changes during the thermal treatment. In this case, the usability of materials for the jacket (105) with chemical compositions that deviate slightly from the material of the body (101, 102, 103) to be thermally treated depends on the similarity of the thermal conductivity of the material of the jacket (105) in comparison with that of the material of the body (101, 102, 103) to be thermally treated. In this case, the thermal conductivity of the jacket (105) may deviate by no more than one tenth of the thermal conductivity of the material of the body (101, 102, 103) to be thermally treated from the thermal conductivity of the material of the body (101, 102, 103) to be thermally treated, preferably by no more than one twentieth and further preferably by no more than one hundredth.

Should the thermal properties of the jacket deviate too much from those of the composite body, the asymmetric temperature distribution in the interior can be avoided by targeted shaping of the external geometry. In the ideal extreme case, the jacket perfectly insulates the heat; in that case, its geometry no longer influences the temperature gradients. In a variant of the invention, the materials used for the jacket (105) and the body (101, 102, 103) to be thermally treated are amorphous silicon-containing glasses or semicrystalline ceramics, for example. In further variants, the materials used are enriched with further component materials in order to improve chemical, physical or optical properties. In particular, the material is a titanium-doped silicate compound.

In a configuration, the body (101, 102, 103) to be thermally treated which is surrounded by the jacket (105) has round cross sections, as depicted in FIG. 1. In a variant, the body (101, 102, 103) to be thermally treated which is surrounded by the jacket (105) has oval cross sections. In specific alternatives, the body (101, 102, 103) to be thermally treated which is surrounded by the jacket (105) has polygonal cross sections.

The medium (111) in the temperature-controllable space (108) of the temperature-control unit (106) is temperature-controlled to a temperature, which can be set freely, in a temperature range between 5° and 1500° C. with the heating element (109) and, as described above in a specific variant of the invention, using the control unit (110). The medium (111) is an inert gas, for example nitrogen or argon, in a variant of the invention. It is high-purity compressed air in a further variant. Gaseous water is added to the gaseous medium in a controlled manner in a further variant. In further variants, the medium (111) is exchanged during the thermal treatment, with the exchange being effected either sequentially or continuously. The exchangeability of the medium (111) for example serves the purpose of removing gaseous substances, which have been formed, from the temperature-controllable space (108). In the process, the medium (111) is exchanged from the temperature-controllable space (108) at a variable exchange rate. It is also possible to at least partially remove the medium (111) through a continuous evacuation of the temperature-controllable space (108) in an application of the apparatus (100). To this end, a pumping apparatus (not shown here) is used to generate a negative pressure relative to the ambient pressure surrounding the apparatus (100). In a further variant of the invention, the medium (111) has a higher pressure than a standard pressure during the thermal treatment.

In a variant of the invention, current-carrying wires, for example heating coils, are used as heating elements (109). In a further variant of the invention, heating elements through which gas flows are used as heating elements (109). In a further variant of the invention, the apparatus (100) comprises a multiplicity of heating elements (109) which are arranged at different locations in the temperature-controllable space (108). In particular, the heating elements (109) are situated on the ceiling of the temperature-controllable space (108), or on its walls, and on the floor.

According to the invention, the temperature of the medium (111) can be set and controlled to a value with an accuracy of at least 10 K, preferably +/−1 K and further preferably +/−0.1 K with the control unit (110) and the heating element (109). In an embodiment, the apparatus (100) and specifically the control unit (110) therefore contain at least one sensor for measuring the temperature of the medium (111). The temperature signals measured by the sensor are then processed in an evaluation unit and returned in a feedback loop to the control unit (110) for controlling a temperature. In an alternative to that or in addition, the control unit (110) in a variant of the invention comprises a sensor which measures the temperature at a surface in the interior of the temperature-control unit (106) or the temperature within the medium (111). A corresponding surface is a surface of the jacket (105) or a surface of the body (101, 102, 103) to be thermally treated.

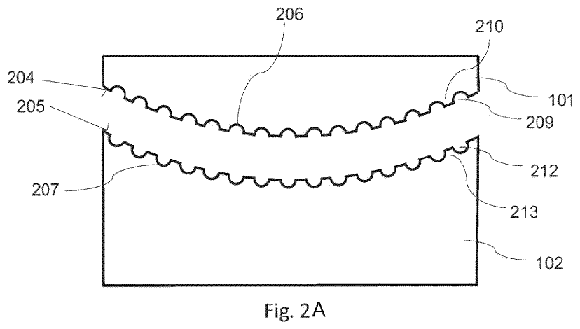

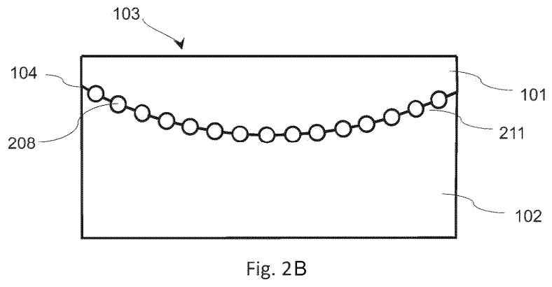

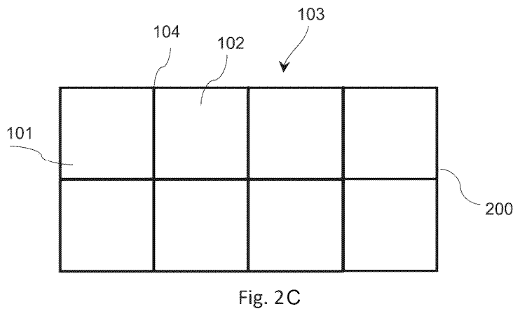

FIGS. 2A and 2B show a specific embodiment of the invention using the example of high-temperature bonding the first partial body (101) to the second partial body (102) in order to form the composite body (103). In a method according to the invention of this embodiment, the first partial body (101) and the second partial body (102) are initially provided. In the shown aspect of the method, the first partial body (101) is formed as an upper partial body and the second partial body (102) is formed as a lower partial body such that a surface (204) of the first partial body (101) is placed on a surface (205) of the second partial body (102) so that the surface (204) and the surface (205) are in contact, as shown in FIG. 2B. This forms an interface (104). In this case, the positions of the first partial body (101) and of the second partial body (102) are interchangeable.

A further variant of the method according to the invention is shown in FIG. 2C, in which a multiplicity of partial bodies (200) are positioned against one another with a stack-sealing method such that a composite body (103) composed of the corresponding multiplicity of partial bodies (200) is created with the high-temperature bonding as a specific variant of the thermal treatment. In this case, two partial bodies (101, 102) of the multiplicity of partial bodies (200) in each case form at least one interface (104) at which the composite body (103) arises during the high-temperature bonding.

In a further embodiment, the first partial body (101) and the second partial body (102) are processed on the surface (204) and the surface (205), respectively, with a chemical and/or a physical processing method before or after being made available, whereby the surface (204) and/or the surface (205) are brought into a predefined and mutually corresponding shape such that the surface (204) and the surface (205) come into at least partial contact when the first partial body (101) and the second partial body (102) are brought together. Since the first partial body (101), the second partial body (102) or the multiplicity of partial bodies (200) may deform during a temperature change proceeding from a state at room temperature to a state at an elevated temperature during the high-temperature bonding, such a temperature-induced change in shape of the shapes of the first partial body (101), of the second partial body (102) or of the multiplicity of partial bodies (200) that can be attained through a chemical and/or physical processing method is taken into account and kept available in the processing method.

In a variant of the invention, a physical processing method is for example a polishing method or a lapping method for polishing the surface (204) and the surface (205) to a defined roughness. In a further variant, a physical processing method is a machining method and/or a different shaping method.

In a further embodiment according to the invention, channels are formed in the body (101, 102, 103) to be thermally treated. To this end, the surface (204) and/or the surface (205) are processed as set forth below. A physical processing method, e.g. a machining method, is used to introduce a structure (206) of the first partial body and/or a structure (207) of the second partial body, each with at least one groove (209) and/or one groove (212) and/or at least one ridge (210) and/or one ridge (213), into the surface (204) and/or into the surface (205), for example. In a further variant, the physical processing method is an ablation method, in which the structure (206) of the first partial body and/or the structure (207) of the second partial body is introduced into the surface (204) and/or the surface (205) with a light source, source of radicals, electron source or ion source. In a variant of the method, this results in at least one continuous channel (208) being formed in the interior of the composite body (103) from the structure (206) of the first partial body and/or the structure (207) of the second partial body during the thermal treatment, in particular during the high-temperature bonding. In a variant, the channel (208) consists of a plurality of partial channels, with two respective partial channels being separated from each other by at least one wall (211). In a further variant, multiple mutually independent continuous channels (208) are formed.

Should a chemical method be used to process the surface of the first partial body (204) and/or the surface of the second partial body (205), a material is applied to the surface of the first partial body (204) and/or the surface of the second partial body (205) and/or removed from the surface of the first partial body (204) and/or the surface of the second partial body (205). In a variant of the invention, a chemical method for processing the surfaces (20, 205) is an additive manufacturing method.

In a variant of a method according to the invention, an etching method, for example, is used to remove material from the surface of the first partial body (204) and/or the surface of the second partial body (205). Preference is given to using a wet-chemical etching method in which liquid and/or gaseous chemicals are used. In a variant of the invention, such a wet-chemical etching method is used to introduce the first structure (206) into the surface of the first partial body (204) and/or the second structure (207) into the surface of the second partial body (205). Instead of a wet-chemical etching method, a dry etching method is alternatively used as processing method in a further variant. In this case, the surface of the first partial body (204) and/or the surfaces (205) are brought into a defined shape, for example with a plasma source or an ion beam source, and/or the first structure (206) and the second structure (207) are introduced into the surface of the first partial body (204) and/or into the surface of the second partial body (205). It is also possible for the first structure (206) and the second structure (207) to be introduced with of a lithographic method.

In a further variant of the invention, the method for processing the surface (204) and/or the surface of the second partial body (205) is a method used to deposit material on the surface of the first partial body (204) and/or the surface of the second partial body (205) or only on a portion of the surface of the first partial body (204) and/or the surface of the second partial body (205) with a chemical and/or physical method. In a variant, atomic layer deposition is for example used to apply a thin layer of at least one atomic layer of a material. In other embodiments, chemical vapor deposition methods or sputtering methods are for example used to deposit a layer of a material onto the surface of the first partial body (204) and/or the surface of the second partial body (205) or onto a portion of the surfaces.

In a further aspect, the interface (104) is formed as a planar interface. In this case, the surface of the first partial body (204) and the surface of the second partial body (205) are also formed as planar surfaces. In a further aspect, the interface (104) is formed as a concave or convex surface. In a further aspect, the interface (104) is configured as a free-form surface. When the interface (104) is configured as a concave surface, convex surface or a free-form surface, the surface of the first partial body (204) and the surface of the second partial body (205) are each formed as a mutually complementary surface such that this gives rise to an extensive contact between the surface of the first partial body (204) and the surface of the second partial body (205).

In a further aspect, the first partial body (101) and the second partial body (102) are particularly advantageously connected to each other with optical contact bonding such that a simpler production of an arrangement of the first partial body (101) and the second partial body (102) can be realized.

If the body (101, 102, 103) to be thermally treated, for example the first partial body (101) and the second partial body (102), is arranged in an arrangement according to the invention as described above, the body (101, 102, 103) to be thermally treated is positioned within the jacket (105) in the temperature-controllable space (108) with the medium (111), as illustrated in FIG. 1, by providing the apparatus (100). In the process, the jacket (105) contactlessly surrounds the body (101, 102, 103) to be thermally treated, as described further above. As a consequence, a body (101, 102, 103) to be thermally treated is produced with thermal treatment. For example, a composite body (103) is produced from the first partial body (101) and the second partial body (102) with high-temperature bonding at the interface (104).

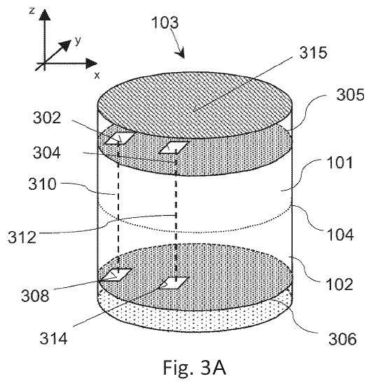

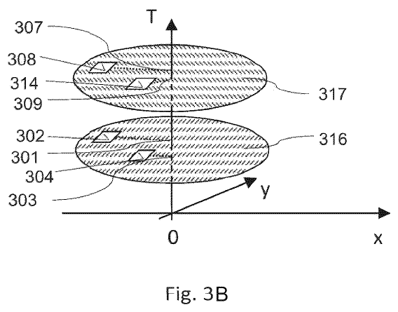

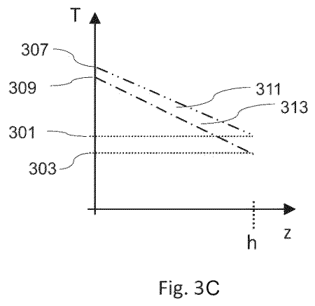

FIG. 3A shows a schematic illustration of a body (101, 102, 103) to be thermally treated during the thermal treatment, with all parts of the apparatus (100) according to the invention having been deliberately omitted in order to better illustrate the partial aspects during the thermal treatment explained below. The body (101, 102, 103) to be thermally treated according to the invention comprises a first arbitrary sectional plane of a first constant height (305) and an arbitrary second sectional plane of a second constant height (306). The first arbitrary sectional plane of the first constant height (305) furthermore comprises a first arbitrary infinitesimal area element (302) and an arbitrary second infinitesimal area element (304). Likewise, the arbitrary second sectional plane of the second constant height (306) comprises an arbitrary third infinitesimal area element (308) and an arbitrary fourth infinitesimal area element (314).

FIG. 3B shows a schematic illustration of an embodiment during a method according to the invention for thermal treatment. As illustrated on the basis of a first temperature distribution (316) within the arbitrary first sectional plane of the first constant height (305), a first local temperature (301) is present at the arbitrary first infinitesimal area element (302) during the thermal treatment, and a second local temperature (303) is present at the arbitrary second infinitesimal area element (304). Likewise, in accordance with a second temperature distribution (317) within the arbitrary second sectional plane of the second constant height (306), a third local temperature (307) is present at the arbitrary third infinitesimal area element (308) during the high-temperature bonding, and a fourth local temperature (309) is present at the arbitrary fourth infinitesimal area element (314). In this definition used below of the sectional planes of constant height (305, 306), the infinitesimal area elements (302, 304, 308, 314), etc., an arbitrary choice of the height of the corresponding sectional plane of constant height (305, 306) of the body (101, 102, 103) to be thermally treated, for example within the composite body (103), means an arbitrary choice of the position of the infinitesimal surface element (302, 304, 308, 314) within a sectional plane of constant height (305, 306), etc., with the restriction that an arbitrary sectional plane (305, 306), an arbitrary area element (302, 304, 308, 314), etc., cannot be the same sectional plane (305, 306), the same infinitesimal area element (302, 304, 308, 314), etc. in each case.

Since the jacket (105) contactlessly surrounds the body (101, 102, 103) to be thermally treated during the high-temperature bonding when the apparatus (100) is used according to the invention, as illustrated inFIG. 1, the jacket (105) at least partially prevents unhindered heat exchange between the medium (111) and the body (101, 102, 103) to be thermally treated, for example via the surface (112) of the composite body (103). According to the invention, such an unhindered heat exchange between the medium (111) and the body (101, 102, 103) to be thermally treated takes place via the surface (315) from FIG. 3A since the surface (315) is not contactlessly surrounded by the jacket (105). As a consequence, the first temperature (301) and the second local temperature (303) assume values deviating from each other by no more than 1 K. Since an insulating effect according to the invention of the jacket (105) does not perfectly suppress thermal conduction within the arbitrary first sectional plane of the first constant height (305), there may be minor temperature differences between the first local temperature (301) and the second local temperature (303), but these should not be greater than 1 K according to the invention.

Since unhindered heat exchange between the medium (111) and the body (101, 102, 103) to be thermally treated takes place via the surface (315) not surrounded by the jacket (105), a first local temperature (301) and a third local temperature (307) may differ from each other at least intermittently on account of a heat exchange arising between the body (101, 102, 103) to be thermally treated and the medium (111) at the surface (315) and on account of an entropy-driven heat transport resulting therefrom within the body (101, 102, 103) to be thermally treated. In this case, a difference between a first local temperature (301) and a third local temperature (307) is greater, the further the arbitrary first sectional plane of the first constant height (305) and the arbitrary sectional plane of the second constant height (306) lie apart and the greater a temperature difference present at least intermittently is between a temperature of the medium (111) or furnace floor and a temperature at the surface (315).

FIG. 3C shows a schematic illustration of a further aspect of a method according to the invention for thermally treating the body (101, 102, 103) to be thermally treated. In this aspect, a first local temperature profile (311) is approximately linear within the body (101, 102, 103) to be thermally treated, when proceeding along a first normal (310), from the arbitrary first infinitesimal area element (302) with a first local temperature (301) toward the arbitrary third infinitesimal area element (308) with the third local temperature (307). In the sense of the invention, a linearity of the temperature profile (311) means that the gradient of a first local temperature profile (311) at an arbitrary height of the body (101, 102, 103) to be thermally treated differs by no more than 5% from an averaged temperature gradient, which is calculated over a corresponding local temperature profile (311) over the entire height of the body (101, 102, 103) to be thermally treated. At the same time, the second local temperature profile (313) is likewise approximately linear within the same body (101, 102, 103) to be thermally treated, when proceeding along the second normal (312) of the arbitrary first sectional plane of the first constant height (305), from the arbitrary second infinitesimal area element (304) with the second local temperature (303) toward the arbitrary fourth infinitesimal area element (314) with the fourth local temperature (309), with a linearity of the second local temperature profile (313) in the sense of the invention being defined analogously to the linearity of the first local temperature profile (311).

Since different expansion states of the material of the body (101, 102, 103) to be thermally treated form in the interior of the body (101, 102, 103) to be thermally treated when the temperature profile (311) and/or the temperature profile (313) form, the temperature profile (311) and/or the temperature profile (313) is associated with a density profile within the material of the body (101, 102,103) to be thermally treated, with the density changing by at least 10 ppm along the temperature profile (311) and/or the temperature profile (313). Since the degree of crystallization of the material of the body (101, 102, 103) to be thermally treated also depends on the temperature, this may lead to a formation of different degrees of crystallization and optionally different crystallization states in the form of thermodynamic phases of the material along the temperature profile (311) and/or the temperature profile (313). In an aspect, the degree of crystallization changes by more than 10 ppm but by no more than 10% along the temperature profile (311) and/or the temperature profile (313). If a temperature profile (311) and/or a temperature profile (313) has a linear profile in the sense of the invention, a density profile may likewise have an analogous linear profile in the same direction. A temperature gradient of the temperature profile (311) and/or a temperature gradient of the temperature profile (313) is 20-1000 K/m here according to the invention, with the temperature gradient averaged over the first local temperature profile (311) and the temperature gradient averaged over the second local temperature profile (313) differing by no more than 5%. In this case, there is an approximately homogeneous heat transport toward the surface (315) over the entire cross section of the body (101, 102, 103) to be thermally treated. Cooling to room temperature according to the invention of the body (101, 102, 103) to be thermally treated thus results in a constant density gradient within the body (101, 102, 103) to be thermally treated, and this causes a reduced formation of stresses in the interior of the body (101, 102, 103) to be thermally treated.

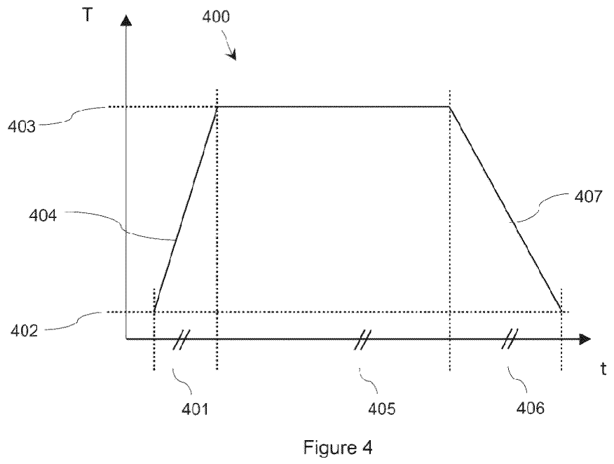

FIG. 4 shows, in a further aspect of an embodiment according to the invention of the method, a schematic illustration of a temporal temperature profile (400) of the medium (111) in the space (108) which can be temperature-controlled with the heating element (109) and the control unit (110). The temporal temperature profile (400) for a complete method of high-temperature bonding comprises a heating phase (401) proceeding from a first temperature (402) toward a second temperature (403), in which the body (101, 102, 103) to be thermally treated is heated using a temporal heating temperature ramp (404), a holding phase (405), in which the body (101, 102, 103) to be thermally treated is thermally treated with a time-constant second temperature (403), and a cooling phase (406) proceeding from the second temperature (403) toward the first temperature (402), in which the body (101, 102, 103) to be thermally treated thermally treated using the aforementioned method is cooled using a temporal cooling temperature ramp (407).

In a specific variant of the invention, the temperature of the medium (111) is controlled in time-varying fashion with the control unit (110) during the entire temperature profile (400), especially during the heating phase (401) and the cooling phase (406). A change in temperature within the temperature profile (400), especially within the heating phase (401) and/or cooling phase (406), controlled with the control unit (110) is translated into a corresponding heating rate or cooling rate.

In a further variant of a method according to the invention, this is a constant heating rate or a constant cooling rate, which leads to a linear change in temperature, for example during the heating phase (401) and the cooling phase (406).

In a further variant of a method according to the invention, a heating rate and a cooling rate are set in time-varying fashion, leading to correspondingly nonlinear changes in temperature within the temperature profile (400), especially for the heating temperature ramp (404) and for the cooling temperature ramp (407). A temporally nonlinearly variable change in temperature is e.g. a sigmoidal change in temperature, a logarithmic change in temperature, an exponential change in temperature or a stepped change in temperature.

The precise durations of the individual phases of heating phase (401), holding phase (405) and cooling phase (406) depend on the materials used in the body (101, 102, 103) to be thermally treated and in the jacket (105) and on the present shapes and geometries thereof. Accurate experimental values can be calculated through finite element simulations, for example. According to the invention, the heating phase (401) and the holding phase (405) have a duration ranging from a few hours to a few days. According to the invention, the cooling phase (406) has a duration ranging from a few hours up to three months, preferably ranging from a week to two months and further preferably ranging from a week to one month.

Since direct contact must exist between the medium (111) and each body (101, 102, 103) to be thermally treated and the jacket (105) in order to establish a heat exchange, the temperature profile (400) at a position in the interior of the body (101, 102, 103) to be thermally treated or of the jacket (105) is similar as a matter of principle to a temperature profile (400) of the medium (111) shown in FIG. 4. In this case, a coefficient of thermal conductivity of the materials used in the body (101, 102, 103) to be thermally treated and in the jacket (105) determines how quickly a change in temperature at a position in the interior of the body (101, 102, 103) to be thermally treated or of the jacket (105) follows a change in temperature of a temperature profile (400) of a medium (111). In order to achieve a temperature distribution that is as uniform as possible in all gaseous and solid materials situated in a temperature-controllable space (108) of the temperature-control unit (106), the invention provides for changes in temperature of the temperature profile (400) of the medium (111) to be specified as no more than 100 K/hour, preferably 1 K/hour and further preferably 0.01 K/hour.

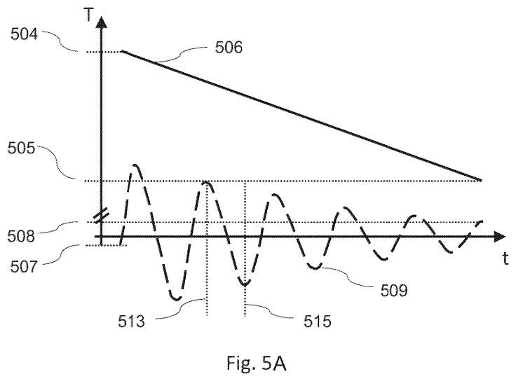

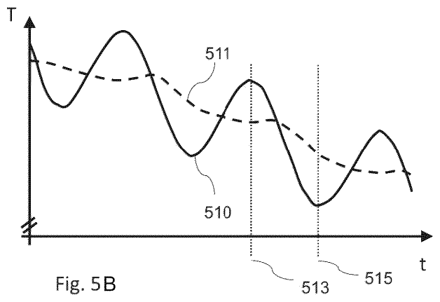

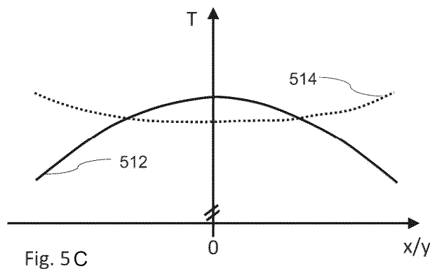

FIG. 5A shows, in a further aspect of an embodiment according to the invention of the method, a schematic illustration of a portion of the temperature profile (400) during the thermal treatment. In this aspect, the adjustable cooling temperature ramp (407) with a temporally non-linear profile of the medium (111) surrounding the jacket (105) and the body (101, 102, 103) to be thermally treated consists of a first component (506) which has an adjustable cooling rate and drops continuously starting from a first temperature (504) to a second temperature (505), the first temperature (504) and the second temperature (505), and also a second component (509) with a periodic temperature change starting from a third temperature (507) to a fourth temperature (508) with the third temperature (507) which is adjustable in each case with the control unit (110), the fourth temperature (508), an amplitude, a period, a phase, and an attenuation and/or an amplification. In this case, the first temperature (504) is advantageously set such that the first temperature (504), in terms of its value, corresponds to the first temperature (403) set during the holding phase (405). The second temperature (505) is advantageously set such that the second temperature (505), in terms of its value, corresponds to the second temperature (402) set during the cooling phase (406). The temperature profile of the first component (506) is configured as a linear profile, an exponential profile, a sigmoidal profile or a logarithmic profile. The third temperature (507) is likewise advantageously set such that the third temperature (507), in terms of its value, corresponds to the second temperature (403) set during the holding phase (405). The fourth temperature (508) is likewise advantageously set such that the fourth temperature (508), in terms of its value, corresponds to the first temperature (402) set during the cooling phase (406). For illustrative purposes, the first component (506) and the second component (509) and the associated temperatures are presented offset on the y-axis, which represents the temperature, for the purposes of illustration. In this case, the value of the third temperature (507) and of the fourth temperature is defined here by setting a period and a phase of a second component (509). Here, the period of the second component (509) is constant over time in a variant of the invention. In a further variant of the invention, the period of the second component is time-variable. The parameters of a cooling temperature ramp (407) which according to the invention can be set by the control unit (110) depend on influences of the embodiment and are ascertained through finite element calculations. The geometry and the dimensions, the material, the thermodynamic phase diagram, the density, the heat capacity, the thermal conductivity, the hardness or the ductility of the material of the body (101, 102, 103) to be thermally treated and/or of the jacket (105) are mentioned in this context. Attention is drawn to the fact that the list above should not be construed as exhaustive.

FIG. 5B shows a schematic illustration of a further aspect of an embodiment according to the invention of the method, a portion of the temperature profile (400) during the thermal treatment. In this aspect, a periodic component (509) of the cooling temperature ramp (407), which is controlled with the operating parameters of the temperature-control unit (106) and optionally of the control unit (110) in a specific embodiment, brings about a first periodic profile of a temperature ramp (511) in the interior of the body (101, 102, 103) to be thermally treated, with the first periodic time profile of the temperature ramp (511) and a second periodic time profile of a temperature ramp (510) of the medium (111) differing in terms of the respective amplitude, the respective phase, the respective frequency, the respective attenuation and/or the respective amplification. In this case, the first periodic profile of the temperature ramp (511) in the interior of the body (101, 102, 103) to be thermally treated follows the second periodic profile of the temperature ramp (510) always with a delay and in attenuated fashion at an arbitrary first time (513) and at an arbitrary second time (515) on account of a heat exchange between the medium (111) and the body (101, 102, 103) to be thermally treated and heat diffusion within the body (101, 102, 103) to be thermally treated during the thermal treatment.

FIG. 5C shows a schematic illustration of a further aspect of an embodiment according to the invention of the method of thermal treatment. In this aspect, setting the operating parameters of the temperature-control unit (106) and, in a specific embodiment, of the control unit (110) brings about the periodic component (509) of the cooling temperature ramp (407) for the medium (111) within the arbitrary first sectional plane of constant height (305), the first spatial temperature profile (512) at the arbitrary first time (513) and the second spatial temperature profile (514) at the second time (515), with the second time (515) being temporally shifted by half a period of the second component (509) of the cooling temperature ramp (407) relative to the arbitrary first time (513) and the first spatial temperature profile (512) having an at least partially inverted profile relative to the second spatial temperature profile (514). Since an insulating effect according to the invention of the jacket (105) does not perfectly suppress thermal conduction to the surface (114) of the body (101, 102, 103) to be thermally treated within the body (101, 102, 103) to be thermally treated, minor temperature differences between the first local temperature (301) of the arbitrary first infinitesimal area element (302) and the second local temperature (303) of the arbitrary second infinitesimal area element (304) occur within the arbitrary first sectional plane of the first constant height (305) during the cooling phase (406) and lead to the formation of the first spatial temperature profile (512). In this case, the basic formation of the first spatial temperature profile (512) of this type is independent of the type of the temporal profile of the cooling temperature ramp (407), which for example is controlled with the control unit (110). The temperature profile (512) and the absolute value of the local temperature gradient however do depend on a temporary cooling rate during the cooling phase (406) and on physical and geometric properties of the body (101, 102, 103) to be thermally treated and of the jacket (105). Determining properties which may be mentioned by way of example are the geometry, the dimensions, the chemical composition, the density, the heat capacity, the thermal conductivity, the hardness, the ductility and the presence of optionally occurring phase transitions in the considered temperature and pressure range in the material of the body (101, 102, 103) to be thermally treated and of the used jacket (105). As a result of an at least partial inversion of the first spatial temperature profile (512) in relation to the second temperature profile (514) caused by a periodic profile of the temperature ramp (511) during the cooling phase (406), mechanical stresses at the interface (104) are at least partially compensated so that a spatial temperature profile averaged over the temporal profile of a full period of the periodic profile of the temperature ramp (511) is minimized, with, according to the invention, the spatial temperature profile averaged over the temporal profile of a full period of the periodic profile of the temperature ramp (511) having a temperature range of <10 K. Since the viscosity changes nonlinearly with the temperature in glasses, mechanical stresses decrease more rapidly in the manner described in the case of a temperature inversion than they are built up in the case of non-temporarily inverted temperature gradients caused purely by heat diffusion. Therefore, short and weak inversions of the temperature are sufficient to reduce the residual stresses.

The amplitude and the period of the periodic change in temperature of the component (509) decisively determine the aspects according to the invention, described in FIG. 5B and FIG. 5C, during the thermal treatment. In this case, the period of the component (509) is chosen in a variant of the method according to the invention so that an amplitude of a wave-shaped heat diffusion in the interior of the body (101, 102, 103) to be thermally treated is attenuated to less than half the amplitude of the periodic change in temperature of the component (509) in the medium (111) during the cooling phase (406). Accordingly, a period according to the invention lies in a temporal range that is greater than one second and less than one month. The amplitude of the periodic change in temperature of the component (509) is set according to the invention such that an inversion of a temperature profile, as depicted schematically in FIG. 5C, is achieved at the arbitrary first time (513) relative to the second time (515). In this case, according to the invention, the amplitude of the periodic change in temperature of the component (509) in the medium (111) during the cooling phase (406) exceeds a maximum temperature difference that occurs during the thermal treatment in the interior of the body (101, 102, 103) to be thermally treated. A maximum amplitude according to the invention of a periodic change in temperature (509) is chosen from the range greater than 5 K and less than 250 K, with the attenuation and/or amplification of the amplitude during the cooling phase being taken into account according to the invention.

In a further variant of the invention, the entire temperature-control method according to FIGS. 4 and 5 is performed multiple times in succession. In a further variant of the invention, the parameters of the temperature-control method are identical among the individual passes. In a further variant, the parameters of the temperature-control method are different among the individual passes. In a further variant of the method, chemical, structural and/or physical properties of the body (101, 102, 103) to be thermally treated are compared between individual passes of the temperature-control method with desired predefined values with a suitable chemical and/or physical measuring method.

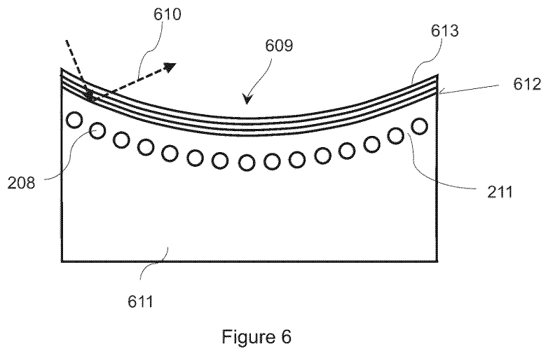

FIG. 6 shows a schematic illustration of an optical element (609) produced by the method according to the invention from the body (101, 102, 103) to be thermally treated. The example shown relates in particular to a reflective optical element (609), further particularly to a reflective optical element (609) for reflecting EUV radiation (610).

In the example shown, the body (101, 102, 103) to be thermally treated is processed on the surface (315) with a chemical and/or physical processing method to form a substrate (611) according to the invention. In the embodiment shown, a surface (612) of the substrate (611) is processed by a chemical and/or physical processing method to form a concavely curved surface. Alternatively, the surface (612) may be processed by a chemical and/or physical processing method to form a planar surface. In a further variant of the invention, the surface (612) may be processed by a chemical and/or physical processing method to form a convex surface or a free-form surface. Furthermore, a reflective coating (613), in particular a coating reflecting EUV radiation, is applied to the substrate (611) at the surface (612) through a second chemical and/or physical processing method. In the example shown, the coating (613) is composed of a multiplicity of alternating layers with in each case different physical properties, in particular optical properties, e.g. refractive index differences. In a variant, the coating (613) is made up of e.g. alternating layers of molybdenum and silicon such that the coating (613) is configured as a coating reflecting EUV light in the spectral range of 5-30 nm, in particular at 13.5 nm.

In a further aspect of an embodiment according to the invention of the optical element (609), at least one continuous channel (208) is configured within the substrate (611) in order to actively heat and/or actively cool, with liquid and/or gaseous media, the substrate (611) and the reflective coating (613), in particular the coating reflecting EUV radiation, applied to the substrate (611) at the surface (612). In this case, as shown in FIG. 6, the at least one continuous channel (208) has a round cross-sectional shape. In a variant of the invention, the cross-sectional shape of the continuous channel (208) has a polygonal or oval configuration. In a further variant of the invention, the at least one continuous channel (208) extends over the entire cross section of the substrate (611), or else over only parts of the cross section of the substrate (611), with individual partial channels of the continuous channel (208) being separated from one another by walls (211). In a variant of the invention, the channel (208) is a spiral channel (208) configured over the cross section of the substrate (611). In another variant, a channel (208) configured over the cross section of the substrate (611) is of meandering form. In further embodiments, linear geometries, geometries bent toward the center of the body (101, 102, 103) to be thermally treated or toward a surface of the substrate (611) or else variants of the at least one channel (208) configured as pseudo-two-dimensional networks over the cross section of the substrate (611) are used. In a further variant, there are a multiplicity of channels, with each individual channel (208) of the multiplicity of channels being configured as an independent channel (208) in each case. In this case, the distance between the channels is constant in a specific variant of the embodiment. In a further specific variant, the distance between the channels varies spatially. In a further variant, the distance between the channels and a surface of the body (101, 102, 103) to be thermally treated is constant. In a further variant, the distance between the channels and a surface of the body (101, 102, 103) to be thermally treated varies. In a further variant, the diameter of the channels in the body (101, 102, 103) to be thermally treated is spatially constant. In a further variant, the diameter of the channels in the body (101, 102, 103) to be thermally treated varies spatially. In a further variant, the shape of the channels in the body (101, 102, 103) to be thermally treated is spatially constant. In a further variant, the shape of the channels in the body (101, 102, 103) to be thermally treated varies spatially.

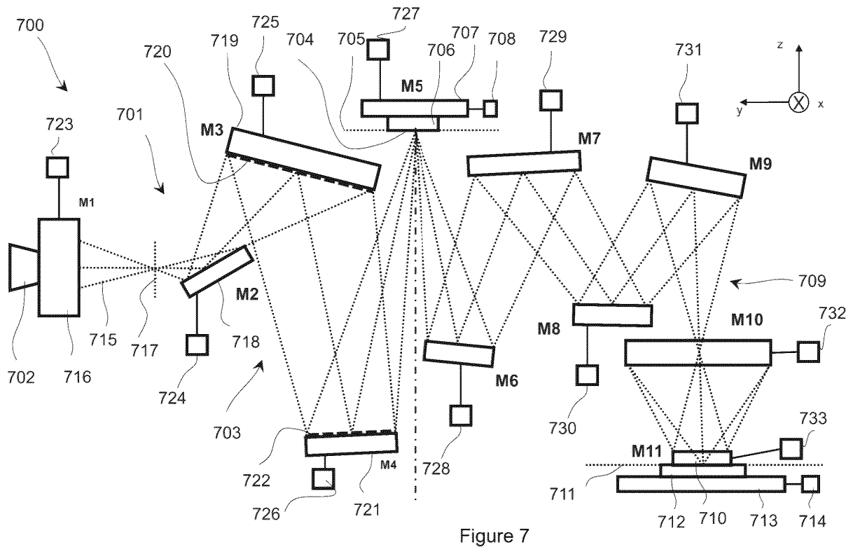

FIG. 7 shows a schematic illustration of a use of the optical element (609) within a semiconductor technology apparatus (700). By way of example, a projection exposure apparatus is shown as a semiconductor technology apparatus (700). The reflective optical element (609) is designed here as one or more mirrors M1-M11 for the reflection of radiation, in particular of EUV radiation. In a further embodiment, the semiconductor technology apparatus (700) may be embodied as a wafer inspection apparatus. In a further embodiment, the semiconductor technology apparatus (700) may be embodied as a mask inspection apparatus. The semiconductor technology apparatus (700) is characterized in that an optical element (609), in particular a reflective optical element (609), is temperature-controlled by a temperature-control device (723-733) through a channel (208) according to the invention situated in the optical element (609), in particular in the reflective optical element (609). The process of controlling the temperature of the optical element (609), in particular of the reflective optical element (609), via a channel (208) is a heating process and/or a cooling process. A medium flows through a channel (208) during a heating process and/or during a cooling process. In the process, the temperature of the medium is controlled with one of the temperature-control devices (723-733). The temperature-control devices (723-733) comprise corresponding ports and lines for supplying or discharging the medium into or out of the at least one channel (208). In a variant of the invention, the temperature-control devices (723-733) comprise at least one pump or the like in order to circulate the medium continuously. It is also possible for the temperature-control devices (723-733) to be connected to a supply unit via a port, with the supply unit not being part of the semiconductor technology apparatus (700) in this case.

In a variant of the invention, the medium used for a heating process and/or a cooling process is water, in particular high-purity water, with the water having a conductance of <0.1 μS/cm. In a further variant, chemical compounds which prevent contamination of the water with biological material are added to the water. In a further variant, chemical compounds which increase the applicable temperature range for the flowing medium or which are designed to reduce corrosion in elements contacted by the water are added to the water. In a further variant of the invention, the medium used for a heating process and/or a cooling process is a gas, in particular high-purity compressed air, furthermore in particular an inert gas, for example nitrogen or argon, or volatile organic compounds or alkali metals.

It is understood that the use of the substrate (611) and of the channel (208) contained therein for controlling the temperature of the substrate (611) and also of the optical element (609) and of the channel (208) contained therein for controlling the temperature of the one optical element (609) is not restricted to a use within a semiconductor technology apparatus (700).

Furthermore, and with reference to FIG. 7, the essential component parts of a semiconductor technology apparatus (700) are described below by way of example, using the example of a microlithographic projection exposure apparatus.

One embodiment of an illumination system (701) of the projection exposure apparatus has, in addition to a radiation source (702), an illumination optics unit (703) for illuminating an object field (704) in an object plane (705). In an alternative embodiment, the light source (702) is also provided as a module separate from the rest of the illumination system. In this case, the illumination system does not include the light source (702).

A reticle (706) arranged in the object field (704) is illuminated. The reticle (706) is held by a reticle holder (707). The reticle holder (707) is displaceable in particular in a scanning direction using a reticle displacement drive (708).

In FIG. 7, a Cartesian xyz-coordinate system is drawn in for elucidation. The x-direction runs perpendicularly to the plane of the drawing into the latter. The y-direction runs horizontally, and the z-direction runs vertically. The scanning direction runs in the y-direction in FIG. 7. The z-direction runs perpendicularly to the object plane (705).

The projection exposure apparatus comprises a projection optics unit (709). The projection optics unit (709) serves for imaging the object field (704) into an image field (710) in an image plane (711). The image plane (711) extends parallel to the object plane (705). In an alternative, an angle that differs from 0° is also possible between the object plane (705) and the image plane (711).

A structure located on the reticle (706) is imaged onto a light-sensitive layer of a substrate (712) arranged in the region of the image field (710) in the image plane (711). In general, this substrate (712) is a wafer. The wafer (712) is held by a wafer holder (713). The wafer holder (713) is displaceable in particular in the y-direction using a wafer displacement drive (714). The displacement, firstly, of the reticle (706) with the reticle displacement drive (708) and, secondly, of the wafer (712) with the wafer displacement drive (714) is implemented so as to be synchronized with each other in a variant of the invention.

The radiation source (702) is an EUV radiation source. The radiation source (702) emits in particular EUV radiation (715), which is also referred to below as used radiation, illumination radiation or illumination light. The used radiation has in particular a wavelength in the range of between 5 nm and 30 nm. In a variant of the invention, the radiation source (702) is a plasma source, for example an LPP (laser produced plasma) source or a GDPP (gas discharge produced plasma) source. In a further variant, it is a synchrotron-based radiation source or else a free electron laser (FEL).

The illumination radiation (715) emanating from the radiation source (702) is focused by a collector (716). In a variant of the invention, the collector (716) is a collector having one or more spherical, ellipsoid, parabolic, cylindrical and/or hyperboloid reflection surfaces, for example with shells of the Wolter type which are nested in one another. In a specific embodiment, the illumination radiation (715) is incident on the at least one reflection surface of the collector (716) with grazing incidence (GI), i.e. at angles of incidence of greater than 45° relative to the direction of the normal to the mirror surface, or with normal incidence (NI), i.e. at angles of incidence of less than 45°. In a further variant, the collector (716) is structured and/or coated on the one hand for optimizing its reflectivity for the used radiation and on the other hand for suppressing extraneous light.

Downstream of the collector (716), the illumination radiation (715) propagates through an intermediate focus in an intermediate focal plane (717). In a variant of the invention, the intermediate focal plane (717) constitutes a separation between a radiation source module, comprising the radiation source (702) and the collector (716), and the illumination optics unit (703).

The illumination optics unit (703) comprises a deflection mirror (718) and, disposed downstream thereof in the beam path, a first facet mirror (719). In a variant of the invention, the deflection mirror (718) is a planar deflection mirror or alternatively a mirror with a beam-influencing effect that goes beyond the pure deflection effect. In an alternative to that or in addition, the deflection mirror (718) in a further variant is in the form of a spectral filter that separates a used light wavelength of the illumination radiation (715) from extraneous light of a wavelength deviating therefrom. Should the first facet mirror (719) be arranged in a plane of the illumination optics unit (703) which is optically conjugate to the object plane (705) as a field plane, this facet mirror is also referred to as a field facet mirror. The first facet mirror (719) comprises a multiplicity of individual first facets (720), which are also referred to below as field facets. Only a few of these facets (720) are illustrated in FIG. 7 by way of example.

In a variant, the first facets (720) are embodied as macroscopic facets, in particular as rectangular facets or as facets with an arcuate edge contour or an edge contour in the form of part of a circle. In a further variant, the first facets (720) are embodied as planar facets or alternatively as convexly or concavely or astigmatically curved facets.

As is known from [DE102008009600A1], for example, the first facets 720 themselves are each also composed of a multiplicity of individual mirrors, in particular a multiplicity of micromirrors, in a further variant. In a specific variant, the first facet mirror (719) is embodied as a microelectromechanical system (MEMS system) in particular. For details, reference is made to [DE102008009600A1].

The illumination radiation (715) travels horizontally, i.e. in the y-direction, between the collector (716) and the deflection mirror (718).

In the beam path of the illumination optics unit (703), a second facet mirror (721) is arranged downstream of the first facet mirror (719). Should the second facet mirror (721) be arranged in a pupil plane of the illumination optics unit (703), this facet mirror is also referred to as a pupil facet mirror. In a further variant, the second facet mirror (721) is also arranged at a distance from a pupil plane of the illumination optics unit (703). In this case, the combination of the first facet mirror (719) and the second facet mirror (721) is also referred to as a specular reflector. Specular reflectors are known from [US20060132747A1] and [U.S. Pat. No. 6,573,978].

The second facet mirror (721) comprises a plurality of second facets (722). In the case of a pupil facet mirror, the second facets (722) are also referred to as pupil facets.

In a specific embodiment, the second facets (722) are macroscopic facets which for example have a round, rectangular or else hexagonal boundary or alternatively are facets composed of micromirrors. In this regard, reference is likewise made to [DE102008009600A1].

In a variant of the invention, the second facets (722) have planar or alternatively convexly or concavely or astigmatically curved reflection surfaces.

The illumination optics unit (703) thus forms a doubly faceted system. This basic principle is also referred to as a fly's eye integrator.

It is advantageous in an embodiment to arrange the second facet mirror (721) not exactly in a plane that is optically conjugate to a pupil plane of the projection optics unit (709). In particular, in a variant the pupil facet mirror (721) is arranged so as to be tilted relative to a pupil plane of the projection optics unit (709), as is for example described in [DE102017220586A1].

The individual first facets (720) are imaged into the object field (704) using the second facet mirror (721). The second facet mirror (721) is the last beam-shaping mirror or else actually the last mirror for the illumination radiation (715) in the beam path upstream of the object field (704).

In a further embodiment (not illustrated) of the illumination optics unit (703), a transfer optics unit contributing in particular to the imaging of the first facets (720) into the object field (704) is arranged in the beam path between the second facet mirror (721) and the object field (704). The transfer optics unit comprises exactly one mirror or alternatively two or more mirrors, which are arranged one behind another in the beam path of the illumination optics unit (703). In further variants, the transfer optics unit in particular comprises one or two normal-incidence mirrors (NI mirrors) and/or one or two grazing-incidence mirrors (GI mirrors).

The projection exposure apparatus comprises a plurality of mirrors Mi, which are consecutively numbered in accordance with their arrangement in the beam path of the projection exposure apparatus.

In the embodiment shown in FIG. 7, the illumination optics unit (703) for example comprises three mirrors downstream of the collector (716) (M1): a deflection mirror 718 (M2), a field facet mirror (719) (M3) and a pupil facet mirror (721) (M4).

In a further embodiment of the illumination optics unit (703), the deflection mirror (718) is omitted, and so the illumination optics unit (703) comprises two mirrors downstream of the collector (716), specifically the first facet mirror (719) and the second facet mirror (721).

The imaging of the first facets (720) into the object plane (705) with the second facets (722) or using the second facets (722) and a transfer optics unit is generally only approximate imaging.

In the example illustrated in FIG. 7, the projection optics unit (709) comprises six mirrors M6 to M11. Alternatives with four, eight, ten, twelve or any other number of mirrors Mi are likewise possible. Odd numbers of mirrors are also possible. The penultimate mirror M10 and the last mirror M11 each have a passage opening for the illumination radiation (715). The projection optics unit (709) is a twice-obscured optics unit. The projection optics unit (709) has an image-side numerical aperture that is greater than 0.5, for example greater than 0.6, or for example is 0.7 or 0.75. Numerical apertures of less than 0.5, for example 0.25 or 0.33, are also possible.

In a variant of the invention, the reflection surfaces of the mirrors Mi are embodied as free-form surfaces without an axis of rotational symmetry. In an alternative, the reflection surfaces of the mirrors Mi are designed as aspherical surfaces with exactly one axis of rotational symmetry of the reflection surface shape. Just like the mirrors of the illumination optics unit (703), the mirrors Mi according to the invention have highly reflective coatings for the illumination radiation (715). According to the invention, these coatings are in the form of multilayer coatings, in particular with alternating layers of molybdenum and silicon.

The projection optics unit (709) has a large object-image shift in the y-direction between a y-coordinate of a center of the object field (704) and a y-coordinate of the center of the image field (710). In the y-direction, this object-image shift is of approximately the same size as a z-distance between the object plane (705) and the image plane (711).

In each case, one of the pupil facets (722) is assigned to exactly one of the field facets (720) for the purpose of forming a respective illumination channel for illuminating the object field (704). It is also possible that a reflection off a field facet (720) may be directed at different pupil facets (722). In particular, this produces illumination according to the Kohler principle. The far field of the source is decomposed into a multiplicity of object fields (704) with the aid of the field facets (720). The field facets (720) generate a plurality of images of the intermediate focus on the pupil facets (722) respectively assigned thereto.

The field facets (720) are each imaged by one or more assigned pupil facets (722) onto the reticle (706) in a manner overlaid on one another in order to illuminate the object field (704). The illumination of the object field (704) is in particular as homogeneous as possible. It preferably has a uniformity error of less than 2%. In a variant, the field uniformity is achieved by overlaying different illumination channels.

The illumination of the entrance pupil of the projection optics unit (709) is defined geometrically with an arrangement of the pupil facets. The intensity distribution in the entrance pupil of the projection optics unit (709) is set by selecting the illumination channels, in particular the subset of the pupil facets which guide light. This intensity distribution is also referred to as illumination setting.

A likewise preferred pupil uniformity in the region of portions of an illumination pupil of the illumination optics unit (703) that are illuminated in a defined manner is attained by a redistribution of the illumination channels.

Further aspects and details of the illumination of the object field (704) and in particular of the entrance pupil of the projection optics unit (709) are described below.

The projection optics unit (709) has a homocentric entrance pupil, in particular. It is accessible in a variant of the invention. It is inaccessible in another variant of the invention.

The entrance pupil of the projection optics unit (709) generally cannot be illuminated exactly with the pupil facet mirror (721). The aperture rays often do not intersect at a single point in the event of imaging by the projection optics unit (709) that telecentrically images the center of the pupil facet mirror (721) onto the wafer (712). However, it is possible to find an area in which the spacing of the aperture rays that is determined in pairs becomes minimal. This area is the entrance pupil or an area conjugate thereto in real space. In particular, this area exhibits a finite curvature.

The projection optics unit (709) has different poses of the entrance pupil for the tangential beam path and for the sagittal beam path in an embodiment. In this case, an imaging element, in particular an optical component part of the transfer optics unit, should be provided between the second facet mirror (721) and the reticle (706). With the aid of this optical element, the different poses of the tangential entrance pupil and the sagittal entrance pupil are taken into account.

In the arrangement of the components of the illumination optics unit (703) illustrated in FIG. 7, the pupil facet mirror (721) is arranged in an area conjugate to the entrance pupil of the projection optics unit (709). The field facet mirror (719) is arranged so as to be tilted with respect to the object plane (705). The first facet mirror (719) is arranged so as to be tilted with respect to an arrangement plane defined by the deflection mirror (718).

The first facet mirror (719) is arranged so as to be tilted with respect to an arrangement plane defined by the second facet mirror (721).

In a further variant, one or more of the mirrors M1-M11 are embodied as reflective optical elements (609) having at least one channel (208) situated in the interior of the reflective optical element (609). In this case, the mirrors M1-M11 include the temperature-control devices (723-733). Here, one of the respective temperature-control devices (723-733) is in each case assigned to one of the elements M1-M11. It is also possible that one of the temperature-control devices (723-733) is used to control the temperature of more than one reflective optical element (609). In this case, the number of temperature-control devices (723-733) required is reduced accordingly. In a variant of the invention, the temperature-control devices (723-733) are designed such that a fluid flowing in the at least one channel (208) is subject to temperature control.

In a variant, the temperature-control devices (723-733) comprise sensors that measure a temperature of the fluid flowing through the at least one channel (208) during the operation of the projection exposure apparatus and control the temperature of the fluid to a defined target value with an integrated control section associated with the temperature-control devices (723-733). The temperature-control devices (723-733) additionally contain sensors for measuring temperatures at positions on the reflective surface of the mirrors M1-M11 or in the vicinity of the reflective surface of the mirrors M1-M11. In this case, the temperature of the fluid flowing through the channel (208) is determined by a comparison of the temperatures of the fluid flowing through the channel (208) and of the positions on the reflective surface of the mirrors M1-M11 or in the vicinity of the reflective surface of the mirrors M1-M11. In further embodiments, the temperature-control devices (723-733) additionally comprise various further sensors, which for example determine the quality of the fluid flowing in the channel (208) through conductance measurements in the fluid, through pH value measurements in the fluid, or through spectroscopic measurements on the fluid. Sensors that measure the flow rate of the fluid are moreover used in further embodiments. Moreover, sensors that measure the pressure of the fluid in the interior of the channel (208) are used in further variants. Signal line units and evaluation units not explicitly shown in FIG. 7 are used for all sensors contained in the temperature-control devices (723-733).

### LIST OF REFERENCE SIGNS

100 Apparatus
101 First partial body
102 Second partial body
103 Composite body
104 Interface
105 Jacket
106 Temperature-control unit
107 Surface
108 Temperature-controllable space
109 Heating element
110 Control unit
111 Medium
112 Surface of a first partial body
113 Surface of a second partial body
114 Surface of a composite body
200 Multiplicity of partial bodies
204 First surface
205 Second surface
206 First structure
207 Second structure
208 Channel
209 Groove
210 Ridge
211 Wall
212 Groove
213 Ridge
301 First local temperature
302 First infinitesimal area element
303 Second local temperature
304 Second infinitesimal area element
305 First sectional plane of a first constant height
306 Second section plane of a second constant height
307 Third local temperature
308 Third infinitesimal area element
309 Fourth local temperature
310 First normal
311 First local temperature profile
312 Second normal
313 Second local temperature profile
314 Fourth infinitesimal area element
315 Surface
316 First temperature distribution
317 Second temperature distribution
400 Temperature profile
401 Heating phase
402 First temperature
403 Second temperature
404 Heating temperature ramp
405 Connection phase
406 Cooling phase
407 Cooling temperature ramp
504 First temperature
505 Second temperature
506 First component
507 Third temperature
508 Fourth temperature
509 Second component
510 First periodic profile of a temperature ramp
511 Second periodic profile of a temperature ramp
512 First spatial temperature profile
513 First time
514 Second spatial temperature profile
515 Second time
609 Element
610 EUV radiation
611 Substrate
612 Surface
613 Coating
700 Semiconductor technology apparatus
701 Illumination system
702 Radiation source
703 Illumination optics unit
704 Object field
705 Object plane
706 Reticle
707 Reticle holder
708 Reticle displacement drive
709 Projection optics unit
710 Image field
711 Image plane
712 Wafer
713 Wafer holder
714 Wafer displacement drive
715 EUV radiation
716 Collector
717 Intermediate focal plane
718 Deflection mirror
719 Facet mirror
720 Facets
721 Facet mirror
722 Facets
723-733 Temperature-control devices
734 Cooling of the wafer chuck
M1-M11 Mirror in a projection exposure apparatus
M5 Reticle

What is claimed is:

1. A thermal treatment apparatus, comprising:
a body to be thermally treated being embodied as
a monolithic body,
or a composite body,
or an arrangement of a first partial body and a second partial body which contact each other at an interface,
a jacket,
a temperature-controllable space within a temperature-control unit, and
one or more heating elements,
wherein
the jacket contactlessly surrounds the body to be thermally treated before, during and after the thermal treatment and
the jacket consists of a same material as the body to be thermally treated.

2. The apparatus as claimed in claim 1, wherein
an outside of the jacket is cylinder-shaped and has an elliptical shape and a numerical eccentricity ranging between 0.0 and 0.1 in cross section of the cylinder.

3. The apparatus as claimed in claim 1, wherein
each surface of the jacket is distanced at least 0.1 mm and at most 30 mm from a nearest surface of the body to be thermally treated.

4. The apparatus as claimed in claim 1, wherein
the body to be thermally treated comprises an amorphous silicon-containing glass and/or a semicrystalline ceramic.

5. The apparatus as claimed in claim 1, wherein
the body to be thermally treated comprises a titanium-doped quartz glass.

6. A method for thermally treating a body to be thermally treated with the apparatus as claimed in claim 1, comprising:
providing the body to be thermally treated,
arranging the body to be thermally treated and the jacket in the temperature-controllable space such that the jacket contactlessly surrounds the body to be thermally treated,
thermally treating the arranged body to be thermally treated and the arranged jacket in the temperature-controllable space.

7. The method as claimed in claim 6, wherein
said thermally treating comprises:
an annealing method and/or
a high-temperature bonding method or stack-sealing.

8. The method as claimed in claim 6, wherein
the body to be thermally treated is formed from amorphous silicon-containing glass and/or from a semicrystalline ceramic.

9. The method as claimed in claim 6, wherein
the body to be thermally treated is formed from titanium-doped quartz glass.

10. The method as claimed in claim 6, wherein
said providing of the body to be thermally treated precedes a processing on a surface of the body to be thermally treated by a physical and/or chemical processing method.

11. The method as claimed in claim 6, wherein
the body to be thermally treated is embodied as the arrangement, and further comprising:
forming the interface between the first partial body and the second partial body as
a planar interface,
a concave or convex interface,
a free-form surface.

12. The method as claimed in claim 11, wherein
said forming of the interface comprises:
forming a first structure having a groove and a ridge in a first surface of the first partial body by physical and/or chemical processing, and/or
forming a second structure having a groove and a ridge in a second surface of the second partial body by physical and/or chemical processing, and
forming at least one continuous channel in an interior of the composite body from the structure situated on the first surface and/or from the structure situated on the second surface when the first partial body and the second partial body are thermally connected to form the composite body.

13. The method as claimed in claim 12,
further comprising:
joining together a plurality of the partial bodies to form the composite body through a stack-sealing method, wherein respective ones of the first partial bodies and the second partial bodies from the plurality of partial bodies contact each other at the interface.

14. The method as claimed in claim 6, wherein
within the body to be thermally treated
a first local temperature of an arbitrary first infinitesimal area element within an arbitrary first sectional plane of a first constant height and a second local temperature of an arbitrary second infinitesimal area element also within the arbitrary first sectional plane of the first constant height differ by no more than 1 K, and
the first local temperature and a third local temperature of an arbitrary third infinitesimal area element within an arbitrary second sectional plane of a second constant height have a non-zero temperature difference.

15. The method as claimed in claim 14, wherein
within the body to be thermally treated
starting from the arbitrary first infinitesimal area element with the first local temperature within the arbitrary first sectional plane of the first constant height, a gradient of a first local temperature profile at an arbitrary height, the gradient being along a first normal of the arbitrary first sectional plane of the first constant height toward the arbitrary third infinitesimal area element with the third local temperature within the arbitrary second sectional plane of the second constant height, differs by no more than 5% from an averaged temperature gradient which is calculated over a corresponding temperature profile over an entire height, and
starting from the arbitrary second infinitesimal area element with the second local temperature within the arbitrary first sectional plane of the first constant height, a gradient of a second local temperature profile at an arbitrary height, the gradient being along a second normal of the arbitrary first sectional plane of the first constant height toward an arbitrary fourth infinitesimal area element with a fourth local temperature within the arbitrary second sectional plane of the second constant height, differs by no more than 5% from the averaged temperature gradient which is calculated over a corresponding temperature profile over the entire height, wherein
the temperature gradient averaged over the first local temperature profile and the temperature gradient averaged over the second local temperature profile differ by no more than 5% from each other.

16. The method as claimed in claim 6,
further comprising temperature profile phases as follows:
a heating phase starting from a first temperature to a second temperature, during which the body to be thermally treated is heated with a temporal heating temperature ramp,
a holding phase, during which the body to be thermally treated is held at the second temperature, which is at least approximately time-constant, and
a cooling phase starting from the second temperature to the first temperature, during which the body to be thermally treated is cooled with a temporal cooling temperature ramp.

17. The method as claimed in claim 16, wherein
the body to be thermally treated is embodied as the arrangement, and
the first partial body and the second partial body are connected to each other with high-temperature bonding or stack-sealing during the heating phase and/or the holding phase and/or the cooling phase.

18. The method as claimed in claim 16, wherein
in the body to be thermally treated and the jacket, the cooling temperature ramp is applied with a temporally non-linear profile.

19. The method as claimed in claim 16, wherein
the cooling temperature ramp comprises a superposition of components as follows:
a first component having a continuously falling temperature profile from a first temperature to a second temperature, and
a second component having a periodic temperature change starting from a third temperature to a fourth temperature with an amplitude, a period, a phase and an attenuation and/or an amplification.

20. The method as claimed in claim 19, wherein
within the arbitrary first sectional plane of a first constant height, the cooling temperature ramp generates, at least once, a first spatial temperature profile at an arbitrary first time and, at least once, a second spatial temperature profile at an arbitrary second time,
with, at the arbitrary first time or the arbitrary second time, the first local temperature at the first infinitesimal area element being greater than the second local temperature at the second infinitesimal area element, and
with the first infinitesimal area element having a smaller distance from the surface than the second infinitesimal area element.
